(19) United States
(12) Patent Application Publication
(10) Pub. No.: US 2025/0075965 A1
(43) Pub. Date: Mar. 6, 2025

(54) REFRIGERATOR

(71) Applicant: SAMSUNG ELECTRONICS CO., LTD., Suwon-si (KR)

(72) Inventors: Suhyeong LIM, Suwon-si (KR); Donghyeon KWAK, Suwon-si (KR); Jaejin LEE, Suwon-si (KR); Hojune JEON, Suwon-si (KR)

(73) Assignee: SAMSUNG ELECTRONICS CO., LTD., Suwon-si (KR)

(21) Appl. No.: 18/753,491

(22) Filed: Jun. 25, 2024

Related U.S. Application Data
(63) Continuation of application No. PCT/KR2024/007369, filed on May 30, 2024.

(30) Foreign Application Priority Data
Aug. 30, 2023 (KR) 10-2023-0114980
Nov. 3, 2023 (KR) 10-2023-0151230
Jan. 17, 2024 (KR) 10-2024-0007697

(51) Int. Cl. F25D 23/02

(52) U.S. Cl. CPC F25D 23/028; F25D 2323/021; F25D 2323/024

(57) ABSTRACT

A refrigerator may include a main body forming a storage compartment; a door configured to open and close the storage compartment and including a guide rail; and a hinge bracket connecting the main body and the door so the door is rotatable between being opened and a closed to respectively open and close the compartment. The hinge bracket may include a guide shaft inserted into the guide rail to guide rotation of the door. The guide rail may include: a first end and a second end where the guide shaft is respectively located when the door is closed and opened, a free area between the first and second end and having a first width, and a limited area between the second end and free area and having a second width less than the first width.

### CROSS-REFERENCE TO RELATED APPLICATIONS

This is a continuation application, under 35 U.S.C. § 111(a), of International Application PCT/KR2024/007369, filed May 30, 2024, which claims priority under 35 U.S.C. § 119 to Korean Patent Application No. 10-2023-0114980, filed Aug. 30, 2023, Korean Patent Application No. 10-2023-0151230, filed Nov. 3, 2023, and Korean Patent Application No. 10-2024-0007697, filed Jan. 17, 2024 in the Korean Intellectual Property Office, the disclosures of which are incorporated herein in their entireties by reference.

### TECHNICAL FIELD

The present disclosure relates to a refrigerator.

### BACKGROUND ART

A refrigerator is a device that is composed of a main body including a storage compartment, and a cold air supply system configured to supply cold air to the storage compartment so as to keep food fresh. The storage compartment includes a refrigerating compartment in which food is kept refrigerated by maintaining the temperature at approximately 0 to 5 degrees Celsius, and a freezing compartment in which food is kept frozen by maintaining the temperature at approximately −30 to 0 degrees Celsius. A front surface of the storage compartment is provided to be open for food entry and exit.

The refrigerator uses a compressor, a condenser, an expander, and an evaporator to repeat a refrigeration cycle of compressing, condensing, expanding, and evaporating a refrigerant. At this time, both the freezing compartment and the refrigerating compartment may be cooled by a single evaporator disposed on the freezing compartment, or the freezing compartment and the refrigerating compartment may each be provided with the evaporator and thus cooled independently of each other.

The refrigerator includes a door that opens and closes the storage compartment. The door is rotatable relative to the main body so as to open and close the storage compartment.

The door may be provided to allow a user to hold a handle disposed on the door, and thus the user can open and close the door relative to the main body by rotating the door. Alternatively, the refrigerator may include a door opening and closing structure configured to easily open or close the door.

### DISCLOSURE

### Technical Problem

The present disclosure is directed to providing a refrigerator including an improved structure to allow a door to be opened automatically.

Further, the present disclosure is directed to providing a refrigerator including an improved structure to guide a position of a door when the door moves between a closed position and an open position.

Further, the present disclosure is directed to providing a refrigerator including an improved structure to allow a speed of a door to gradually decrease in a process of opening the door.

Further, the present disclosure is directed to providing a refrigerator including an improved structure to allow a door to open at a constant angle.

Further, the present disclosure is directed to providing a refrigerator including an improved structure to allow a door to maintain a position thereof when the door is fully opened.

Technical tasks to be achieved in this document are not limited to the technical tasks mentioned above, and other technical tasks not mentioned will be clearly understood by those skilled in the art from the description below.

### Technical Solution

A refrigerator according to an embodiment of the present disclosure may include: a main body forming a storage compartment; a door configured to open and close the storage compartment and including a guide rail; and a hinge bracket connecting the main body and the door so that the door is rotatable about a rotation axis between an open position at which the storage compartment is open, and a closed position at which the storage compartment is closed. The guide rail may be spaced apart from the rotation axis. The hinge bracket may include a guide shaft inserted into the guide rail and configured to guide rotation of the door. The guide rail may include: a first end where the guide shaft is located when the door is in the closed position, a second end where the guide shaft is located when the door is in the open position; a free area between the first end and the second end and having a first width, and a limited area between the second end and the free area and having a second width which is less than the first width.

A portion of the guide shaft inserted into the guide rail may have a width which is greater than the second width.

A portion of the guide shaft inserted into the guide rail may have a width which is less than the first width.

An area of the guide rail between the second end and the limited area may have a width which is greater than a width of a portion of the guide shaft inserted into the guide rail.

An area of the guide rail between the second end and the limited area may have a width which is equal to the first width.

The free area may extend from the first end toward the limited area.

A length of the free area may be greater than a length of the limited area.

The guide rail may be on a surface of the door facing the hinge bracket, and the guide shaft may extend from the hinge bracket toward the guide rail.

A refrigerator according to an embodiment of the present disclosure may further include: a hinge shaft coupled to the door and the hinge bracket, and which passes through the rotation axis, wherein the guide rail is spaced apart from the hinge shaft.

The guide rail may be recessed from an outer surface of the door in a direction parallel to the rotation axis, and the guide shaft may be parallel to the rotation axis.

The first end may be in contact with the guide shaft when the door is in the closed position, and the second end may be in contact with the guide shaft when the door is in the open position.

The door may be rotatable to the open position by rotating the door in a first direction about the rotation axis, the door may be rotatable to the closed position by rotating the door in a second direction about the rotation axis which is opposite to the first direction, when the door is in the closed position, the first end may be in contact with the guide shaft to prevent further rotation of the door in the second direction, and when the door is in the open position, the second end may be in contact with the guide shaft to prevent further rotation of the door in the first direction.

A refrigerator according to an embodiment of the present disclosure may further include: a hinge shaft coupled to the door and to the hinge bracket, and which passes through the rotation axis, wherein the door may further include a shaft coupling member to which the hinge shaft is coupled, and the guide rail may be coupled to the door so as to be separable from the shaft coupling member.

A refrigerator according to an embodiment of the present disclosure may further include: a lever which may be movably mounted on the door and configured to transmit an elastic force to the door while the door is being rotated between the open position and the closed position; and a guide which may be fixed to the main body and configured to guide movement of the lever by being in contact with the lever while the door is being rotated between the open position and the closed position. The guide may include: a first contact surface which may be configured so that, the lever transmits the elastic force to the door in a direction, in which the door rotates to the closed position, when the lever contacts to the first contact surface, and a second contact surface which may be configured so that, the lever transmits the elastic force to the door in a direction, in which the door rotates to the open position, when the lever contacts to the second contact surface. The storage compartment may be opened by rotating the door in a first direction with respect to the rotation axis, and the storage compartment may be closed by rotating the door in a second direction with respect to the rotation axis which is opposite to the first direction. When the door is located in a position rotated in the first direction from a position in which the lever is in contact with the second contact surface, the guide shaft may be in the limited area or may be in an area between the limited area and the second end.

The limited area may be an opening limited area; and the guide rail may further include a closing limited area between the first end and the free area and having a third width which is less than the first width.

A refrigerator according to an embodiment of the present disclosure may include a main body forming a storage compartment; a door configured to open and close the storage compartment and including a guide rail; and a hinge bracket connecting the main body and the door so that the door is rotatable about a rotation axis between an open position at which the storage compartment is open, and a closed position at which the storage compartment is closed. The guide rail may be spaced apart from the rotation axis. The hinge bracket may include a guide shaft inserted into the guide rail and configured to guide rotation of the door. The guide rail may include: a first end where the guide shaft is located when the door is in the closed position, a second end where the guide shaft is located when the door is in the open position, a free area between the first end and the second end and having an arc shape approximately centered on the rotation axis, a limited area between the second end and the free area and having a linear shape so that the limited area interferes with the relative movement of the guide shaft in the guide rail in the limited area.

A refrigerator according to an embodiment of the present disclosure may include a main body forming a storage compartment; a door configured to open and close the storage compartment and provided to be rotatable with respect to the main body, and including a guide rail spaced apart from a rotation axis of the door; and a guide shaft provided to maintain a fixed position with respect to the main body and inserted into the guide rail to guide rotation of the guide rail. The guide rail may include a first end in which the guide shaft is located in response to the door being in a closed position; a second end in which the guide shaft is located in response to the door being in an open position; a free area disposed between the first end and the second end and having a width greater than or equal to a diameter of a portion of the guide shaft inserted into the guide rail; and a limited area disposed between the second end and the free area and having a width less than the diameter of the portion of the guide shaft inserted into the guide rail.

A refrigerator according to an embodiment of the present disclosure may include a main body forming a storage compartment; a door provided to be rotatable with respect to the main body between an open position in which the storage compartment is opened, and a closed position in which the storage compartment is closed, and including a guide rail spaced apart from a rotation axis of the door; and a hinge bracket provided to connect the main body and the door and including a guide shaft inserted into the guide rail and provided to guide the guide rail in response to the rotation of the door. The guide rail may include a free area in which the guide shaft is located in response to the door being rotated from the closed position by a first opening angle; and a limited area in which the guide shaft is located in response to the door being rotated from the closed position by a second opening angle greater than the first opening angle. The free area may have a first ratio of a width to a width of a portion of the guide shaft inserted into the free area in response to the guide shaft being located in the free area; and the limited area may have a second ratio, which is less than the first ratio, of a width to a width of a portion of the guide shaft inserted into the limited area in response to the guide shaft being located in the limited area.

### DESCRIPTION OF DRAWINGS

FIG. 1 is a perspective view of a refrigerator according to one embodiment of the present disclosure.

FIG. 2 is a top view illustrating a top table separated from the refrigerator according to one embodiment of the present disclosure.

FIG. 3 is a view illustrating the top table and a door opening device of the refrigerator according to one embodiment of the present disclosure when a door pusher is located at a first pusher position.

FIG. 4 is a view illustrating the top table and the door opening device of the refrigerator according to one embodiment of the present disclosure when the door pusher is located at a second pusher position.

FIG. 5 is a view illustrating a partial configuration of the refrigerator according to one embodiment of the present disclosure.

FIG. 6 is a view illustrating a lever device and a guide of the refrigerator according to one embodiment of the present disclosure.

FIG. 7 is a view illustrating a state in which the door pusher presses the door when a roller of the lever is in contact with a first contact surface of the guide in the refrigerator according to one embodiment of the present disclosure.

FIG. 8 is a view illustrating a state in which the door pusher presses the door when the roller of the lever is in contact with a curved point of the guide in the refrigerator according to one embodiment of the present disclosure.

FIG. 9 is a view illustrating a state in which the door pusher in a stopped state when the roller of the lever is in contact with a second contact surface of the guide in the refrigerator according to one embodiment of the present disclosure.

FIG. 10 is an exploded view illustrating some configurations of the refrigerator according to one embodiment of the present disclosure.

FIG. 11 is a view illustrating some configurations of the refrigerator according to one embodiment of the present disclosure.

FIG. 12 is a view illustrating the configuration of the door, a shaft coupling member, a hinge shaft, and a guide rail of the refrigerator according to one embodiment of the present disclosure.

FIG. 13 is a view illustrating the guide rail and a guide shaft when the door of the refrigerator according to one embodiment of the present disclosure is located in a closed position.

FIG. 14 is a view illustrating the guide rail and the guide shaft when the door of the refrigerator according to one embodiment of the present disclosure rotates from the closed position to an open position.

FIG. 15 is a view illustrating the guide rail and the guide shaft when the door of the refrigerator according to one embodiment of the present disclosure rotates from the closed position to the open position.

FIG. 16 is a view illustrating the guide rail and the guide shaft when the door of the refrigerator according to one embodiment of the present disclosure rotates from the closed position to the open position.

FIG. 17 is a bottom view illustrating some configurations of the refrigerator according to one embodiment of the present disclosure.

FIG. 18 is an exploded view illustrating some configurations of the refrigerator according to one embodiment of the present disclosure.

FIG. 19 is a view illustrating a configuration of a door, a shaft coupling member, a hinge shaft, and a guide rail of a refrigerator according to one embodiment of the present disclosure.

FIG. 20 is a view illustrating a configuration of a door, a shaft coupling member, a hinge shaft, and a guide rail of a refrigerator according to one embodiment of the present disclosure.

FIG. 21 is a view illustrating a configuration of a door, a shaft coupling member, a hinge shaft, and a guide rail of a refrigerator according to one embodiment of the present disclosure.

FIG. 22 is a view illustrating a configuration of a door, a guide shaft, a hinge bracket, and a guide rail when the door of a refrigerator according to one embodiment of the present disclosure is in a closed position.

FIG. 23 is a view illustrating the configuration of the door, the guide shaft, the hinge bracket, and the guide rail when the door of the refrigerator according to one embodiment of the present disclosure is in an open position.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1st”, “2nd”, “primary” or “secondary” may be used simply to distinguish a component from other components, without limiting the component in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of each component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

A refrigerator according to an embodiment of the disclosure may include a main body.

The “main body” may include an inner case, an outer case positioned outside the inner case, and an insulation provided between the inner case and the outer case.

The “inner case” may include a case, a plate, a panel, or a liner forming a storage room. The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate inside of the storage room from outside of the storage room to maintain inside temperature of the storage room at appropriate temperature without being influenced by an external environment of the storage room. According to an embodiment of the disclosure, the insulation may include a foaming insulation. The foaming insulation may be molded by fixing the inner case and the outer case with jigs, etc. and then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a forming insulation. The vacuum insulation may include a core material and a cladding material accommodating the core material and sealing the inside with vacuum or pressure close to vacuum. However, the insulation is not limited to the above-mentioned foaming insulation or vacuum insulation, and may include various materials capable of being used for insulation.

The “storage room” may include a space defined by the inner case. The storage room may further include an inner case defining a space corresponding to a storage room. Various goods, such as food, medicine, cosmetics, etc., may be stored in the storage room, and the storage room may open at at least one side to put the goods in or take the goods out.

The refrigerator may include one or more storage rooms. In a case in which two or more storage rooms are formed in the refrigerator, the respective storage rooms may have different purposes of use, and may be maintained at different temperature. To this end, the storage rooms may be partitioned by a partition wall including an insulation.

The storage room may be maintained within an appropriate temperature range according to a purpose of use, and include a “refrigerating room”, a “freezing room”, and a “temperature conversion room” according to purposes of use and/or temperature ranges. The refrigerating room may be maintained at appropriate temperature to keep food refrigerating, and the freezing room may be maintained at appropriate temperature to keep food frozen. The “refrigerating” may be keeping food cold without freezing the food, and for example, the refrigerating room may be maintained within a range of 0 degrees Celsius to 7 degrees Celsius. The “freezing” may be freezing food or keeping food frozen, and for example, the freezing room may be maintained within a range of −20 degrees Celsius to −1 degrees Celsius. The temperature conversion room may be used as any one of a refrigerating room or a freezing room according to or regardless of a user's selection.

The storage room may also be called various other terms, such as “vegetable room”, “freshness room”, “cooling room”, and “ice-making room”, in addition to “refrigerating room”, “freezing room”, and “temperature conversion room”, and the terms, such as “refrigerating room”, “freezing room”, “temperature conversion room”, etc., as used below need to be understood to represent storage rooms having the corresponding purposes of use and the corresponding temperature ranges.

The refrigerator according to an embodiment of the disclosure may include at least one door configured to open or close the open side of the storage room. The respective doors may be provided to open and close one or more storage rooms, or a single door may be provided to open and close a plurality of storage rooms. The door may be rotatably or slidably mounted on the front of the main body.

The “door” may seal the storage room in a closed state. The door may include an insulation, like the main body, to insulate the storage room in the closed state.

According to an embodiment, the door may include an outer door plate forming the front surface of the door, an inner door plate forming the rear surface of the door and facing the storage room, an upper cap, a lower cap, and a door insulation provided therein.

A gasket may be provided on the edge of the inner door plate to seal the storage room by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forms the front surface of the door. The door body may include an outer door plate that forms the front surface of the door body, an inner door plate that forms the rear surface of the door body and faces the storage room, an upper cap, a lower cap, and a door insulator provided therein.

The refrigerator may be classified as French Door Type, Side-by-side Type, Bottom Mounted Freezer (BMF), Top Mounted Freezer (TMF), or One Door Refrigerator depending on the arrangement of the doors and the storage rooms.

The refrigerator according to an embodiment of the disclosure may include a cool air supply device for supplying cool air to the storage room.

The “cool air supply device” may include a machine, an apparatus, an electronic device, and/or a combination system thereof, capable of generating cool air and guiding the cool air to cool the storage room.

According to an embodiment of the disclosure, the cool air supply device may generate cool air through a cooling cycle including compression, condensation, expansion, and evaporation processes of refrigerants. To this end, the cool air supply device may include a cooling cycle device having a compressor, a condenser, an expander, and an evaporator to drive the cooling cycle. According to an embodiment of the disclosure, the cool air supply device may include a semiconductor such as a thermoelectric element. The thermoelectric element may cool the storage room by heating and cooling actions through the Peltier effect.

The refrigerator according to an embodiment of the disclosure may include a machine room where at least some components belonging to the cool air supply device are installed.

The “machine room” may be partitioned and insulated from the storage room to prevent heat generated from the components installed in the machine room from being transferred to the storage room. To dissipate heat from the components installed inside the machine room, the machine room may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice generated in the ice-making tray.

The refrigerator according to an embodiment of the disclosure may include a controller for controlling the refrigerator.

The “controller” may include a memory for storing and/or memorizing data and/or programs for controlling the refrigerator, and a processor for outputting control signals for controlling the cool air supply device, etc. according to the programs and/or data memorized in the memory.

The memory may store or record various information, data, commands, programs, and the like necessary for operations of the refrigerator. The memory may store temporary data generated while generating control signals for controlling components included in the refrigerator. The memory may include at least one of volatile memory or non-volatile memory, or a combination thereof.

The processor may control the overall operation of the refrigerator. The processor may control the components of the refrigerator by executing programs stored in memory. The processor may include a separate neural processing unit (NPU) that performs an operation of an artificial intelligence (AI) model. In addition, the processor may include a central processing unit (CPU), a graphics processor (GPU), and the like. The processor may generate a control signal to control the operation of the cool air supply device. For example, the processor may receive temperature information of the storage room from a temperature sensor, and generate a cooling control signal for controlling an operation of the cool air supply device based on the temperature information of the storage room.

Furthermore, the processor may process a user input of a user interface and control an operation of the user interface according to the programs and/or data memorized/stored in the memory. The user interface may be provided using an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all the components included in the refrigerator, and may include a plurality of processors and a plurality of memories for individually controlling the components of the refrigerator. For example, the refrigerator may include a processor and a memory for controlling the operation of the cool air supply device according to an output of the temperature sensor. In addition, the refrigerator may be separately equipped with a processor and a memory for controlling the operation of the user interface according to the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Hereinafter, various embodiments according to the disclosure will be described in detail with reference to the accompanying drawings.

The terms “up,” “down,” “front,” “rear,” and the like used in the following description are defined with reference to the drawings, and the shape and position of each element are not limited by these terms. For example, the terms “front” and “rear” below may refer to the front and rear of the refrigerator in an X direction relative to the drawings, respectively. The terms “up” and “down” may refer to upwardly in a Z-direction and downwardly in the Z-direction of the refrigerator, respectively, relative to the drawings. The terms “left” and “right” may refer to the left side of the refrigerator in a Y-direction and the right side of the refrigerator in the Y-direction, respectively, relative to the drawings.

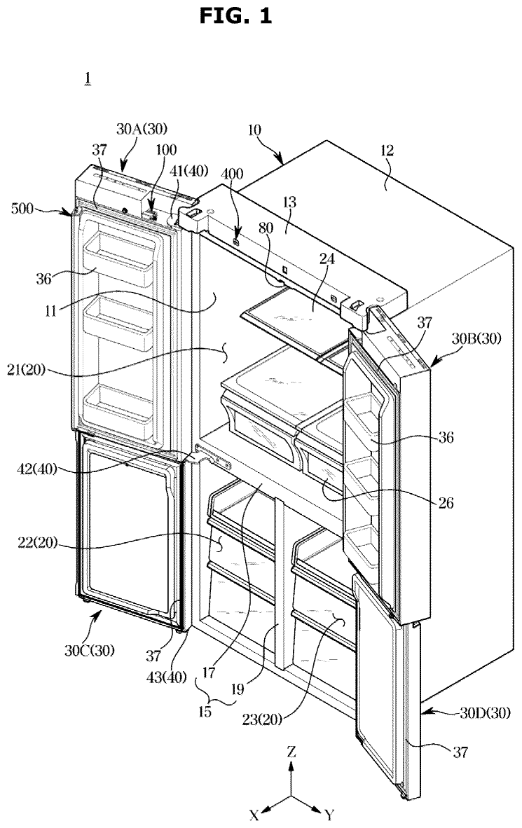

FIG. 1 is a perspective view of a refrigerator according to one embodiment of the present disclosure.

Referring to FIG. 1, a refrigerator 1 according to one embodiment of the present disclosure may include a main body 10, a storage compartment 20 disposed inside the main body 10, a door 30 configured to open and close the storage compartment 20, and a cooling system for supplying cold air to the storage compartment 20.

The main body 10 may include an inner case 11 provided to form the storage compartment 20 and an outer case 12 provided to form an exterior of the refrigerator 1.

The outer case 12 may be formed to have the shape of a box in which a front surface is open. The outer case 12 may form an upper surface, a lower surface, left and right surfaces, a rear surface, etc. of the refrigerator 1.

A front surface of the inner case 11 may be open. The storage compartment 20 may be disposed in the inner case 11 and the inner case 11 may be disposed inside the outer case 12. An inner wall of the inner case 11 may form an inner wall of the storage compartment 20.

A body insulation material may be disposed between the outer case 12 and the inner case 11 of the main body 10 to allow the outer case 12 and the inner case 11 to be insulated from each other.

The storage compartment 20 may be formed inside the main body 10. For example, the storage compartment 20 may include a refrigerating compartment in which food is kept refrigerated by maintaining the temperature at approximately 0 to 5 degrees Celsius. For example, the storage compartment 20 may include a freezing compartment in which food is kept frozen by maintaining the temperature at approximately −30 to 0 degrees Celsius.

For example, the storage compartment 20 may be divided into a plurality of regions by a partition 15. Particularly, by a first partition 17 extending in the horizontal direction, the storage compartment 20 may be divided into a first storage compartment 21 disposed in an upper portion thereof and lower storage compartments 22 and 23 disposed in a lower portion thereof. In addition, the storage compartments 22 and 23 disposed in the lower portion the storage compartment 20 may be divided into a second storage compartment 22 on the left and a third storage compartment 23 on the right by a second partition 19 extending in the vertical direction. At this time, the first storage compartment 21 may be used as the refrigerating compartment. Both the second storage compartment 22 and the third storage compartment 23 may be used as the freezing compartment. Alternatively, one of the second storage compartment 22 and the third storage compartment 23 may be used as the freezing compartment and the other of the second storage compartment 22 and the third storage compartment 23 may be used as the refrigerating compartment.

The above-mentioned division method of the storage compartment 20 and the purposes of each of the divided storage compartments 21, 22, and 23 are only examples and are not limited thereto.

A shelf 24 on which food is placed and a storage container 26 in which food is stored may be provided in the storage compartment 20.

The refrigerator 1 may include a cooling system configured to generate cold air using a refrigeration cycle and supply the generated cold air to the storage compartment 20. The cooling system may generate cold air using a refrigeration circulation cycle that compresses, condenses, expands, and evaporates a refrigerant. For example, the cooling system may include a compressor, a condenser, an expansion valve, an evaporator, a blower fan, etc.

The main body 10 may include a cold air supply duct provided to form a cold air flow path through which cold air generated by the cooling system flows into the storage compartment 20. The cold air supply duct may be formed in a rear portion of the inner case 11, and may be disposed at the rear of the storage compartment 20 and communicate with the storage compartment 20.

The door 30 may be configured to open and close the storage compartment 20. The door 30 may be configured to open and close an opening formed on one side of the main body 10. The door 30 may be configured to be rotatable with respect to the main body 10.

An outer surface of the door 30 may form a portion of the exterior of the refrigerator 1. When the door 30 is in a closed position, the outer surface of the door 30 may form at least a portion of a front exterior of the refrigerator 1. When the door 30 is in the closed position, an inner surface of the door 30 may face the inside of the storage compartment 20. The inner surface of the door 30 refers to one surface of the door 30 facing the storage compartment 20 when the door 30 closes the storage compartment 20. In addition, the outer surface of the door 30 refers to the other surface opposite to the inner surface of the door 30 facing the storage compartment 20 when the door 30 closes the storage compartment 20, and refers to the front surface of the door 30 when the refrigerator 1 is viewed from the front.

A door gasket 37 provided to seal a gap between the door 30 and the main body 10 to prevent the leakage of cold air of the storage compartment 20 may be disposed on the inner surface of the door 30. The door gasket 37 may be arranged along an inner circumference of the door 30. The door gasket 37 may be formed of an elastic material such as rubber.

The refrigerator 1 may include a plurality of doors 30A, 30B, 30C, and 30D configured to open and close each partitioned storage compartment 21, 22, and 23.

Particularly, the first storage compartment 21 may be opened and closed by a pair of upper doors 30A and 30B. The refrigerator 1 may include a first door 30A configured to open and close a portion of the first storage compartment 21 and a second door 30B configured to open and close another portion of the first storage compartment 21. The first door 30A and the second door 30B may each be rotatable independently of each other with respect to the main body 10.

The first door 30A and the second door 30B may be arranged side by side with each other. Particularly, the first door 30A and the second door 30B may be arranged side by side in the horizontal direction (Y direction). For example, the first door 30A may be configured to open and close a left portion of the first storage compartment 21, and the second door 30B may be configured to open and close a right portion of the first storage compartment 21.

The refrigerator 1 may include a rotation bar 500. The rotation bar 500 may be configured to be rotatable with respect to one of the pair of upper doors 30A and 30B (e.g., first door 30A), and provided to cover a gap between the pair of upper doors 30A and 30B when the pair of upper doors 30A and 30B closes the first storage compartment 21.

Further, the second storage compartment 22 may be opened and closed by a lower left door 30C. The refrigerator 1 may include a third door 30C configured to open and close the second storage compartment 22. The third door 30C may be configured to be rotatable with respect to the main body 10. For example, the first door 30A and the third door 30C may be arranged side by side in the vertical direction (Z).

Further, the third storage compartment 23 may be opened and closed by a lower right door 30D. The refrigerator 1 may include a fourth door 30D configured to open and close the third storage compartment 23. The fourth door 30D may be configured to be rotatable with respect to the main body 10. For example, the second door 30B and the fourth door 30D may be arranged side by side in the vertical direction (Z). Additionally, the third door 30C and the fourth door 30D may be arranged side by side in the horizontal direction (Y).

For example, a handle may be provided on each of the plurality of doors 30A, 30B, 30C, and 30D, and a user can hold the handle provided on each of the plurality of doors 30A, 30B, 30C, and 30D to open and close each door 30A, 30B, 30C, and 30D. In other words, a user can open or close each storage compartment 21, 22, and 23 by holding the handle provided on each of the plurality of doors 30A, 30B, 30C, and 30D.

For example, the handle provided on each of the plurality of doors 30A, 30B, 30C, and 30D may include a concave groove shape for gripping.

For example, a door basket 36 provided to store food may be disposed on a rear surface of the first door 30A. For example, the door basket 36 provided to store food may be disposed on a rear surface of the second door 30B.

The refrigerator 1 may include a hinge bracket 40 provided to connect the main body 10 and the door 30. The hinge bracket 40 may be provided to allow the door 30 to be rotatable with respect to the main body 10.

The hinge bracket 40 may be fixed to the main body 10. Particularly, the hinge bracket 40 may be coupled to the outer case 12.

The hinge bracket 40 may rotatably support the door 30. The door 30 may be rotatably coupled to the main body 10 by the hinge bracket 40. A rotation axis of the door 30 may pass through the hinge bracket 40.

Particularly, the refrigerator 1 may include a plurality of hinge brackets 41, 42, and 43 provided to support each of the plurality of doors 30A, 30B, 30C, and 30D.

For example, the refrigerator 1 may include an upper door hinge bracket 41. The upper door hinge bracket 41 may be coupled to an upper portion of the main body 10. For example, the upper door hinge bracket 41 may be provided as a pair so as to rotatably support the first door 30A and the second door 30B, respectively. The pair of upper door hinge brackets 41 may be disposed on the upper left and upper right sides of the main body 10, respectively. Each of the pair of upper door hinge brackets 41 may be coupled to an upper portion of the first door 30A and an upper portion of the second door 30B.

For example, the refrigerator 1 may include a lower door hinge bracket 43. The lower door hinge bracket 43 may be coupled to a lower portion of the main body 10. For example, the lower door hinge bracket 43 may be provided as a pair so as to rotatably support the third door 30C and the fourth door 30D, respectively. The pair of lower door hinge brackets 43 may be disposed on the lower left and lower right sides of the main body 10, respectively. Each of the pair of lower door hinge brackets 43 may be coupled to a lower portion of the third door 30C and a lower portion of the fourth door 30D.

For example, the refrigerator 1 may include an intermediate hinge bracket 42. The intermediate hinge bracket 42 may be coupled to a middle portion of the main body 10. The intermediate hinge bracket 42 may be disposed between the upper door hinge bracket 41 and the lower door hinge bracket 43. For example, the intermediate hinge bracket 42 may be provided as a pair so as to rotatably support the first door 30A and the second door 20B, respectively. Additionally, the intermediate hinge brackets 42 may be provided as a pair so as to rotatably support the third door 30C and the fourth door 30D, respectively. The pair of intermediate hinge brackets 42 may be provided on the left and right sides of the middle portion of the main body 10, respectively. Each of the pair of intermediate hinge brackets 42 may be coupled to the lower portion of the first door 30A and the lower portion of the second door 20B. Additionally, each of the pair of intermediate hinge brackets 42 may be coupled to the upper portion of the third door 30C and the upper portion of the fourth door 30D.

The upper door hinge bracket 41 and the intermediate hinge bracket 42 may be arranged side by side along the direction in which the rotation axes of the first door 30A and the second door 30B extend. As shown in FIG. 1, the upper door hinge bracket 41 and the intermediate hinge bracket 42 may be arranged side by side in the vertical direction (Z).

The lower door hinge bracket 43 and the intermediate hinge bracket 42 may be arranged side by side along the direction in which the rotation axes of the third door 30C and the fourth door 30D extend. As shown in FIG. 1, the lower door hinge bracket 43 and the intermediate hinge bracket 42 may be arranged side by side in the vertical direction (Z).

A detailed description of the structure of the hinge bracket 40 will be described later.

The main body 10 may further include a top table 13 disposed on the upper portion of the main body 10. Particularly, the top table 13 may be coupled to the upper portion of the outer case 12. The top table 13 may be coupled to an upper surface of the outer case 12. The top table 13 may be fixed to the outer case 12.

The top table 13 may cover the upper door hinge bracket 41. Accordingly, the top table 13 may be referred to as ‘hinge bracket cover 13’.

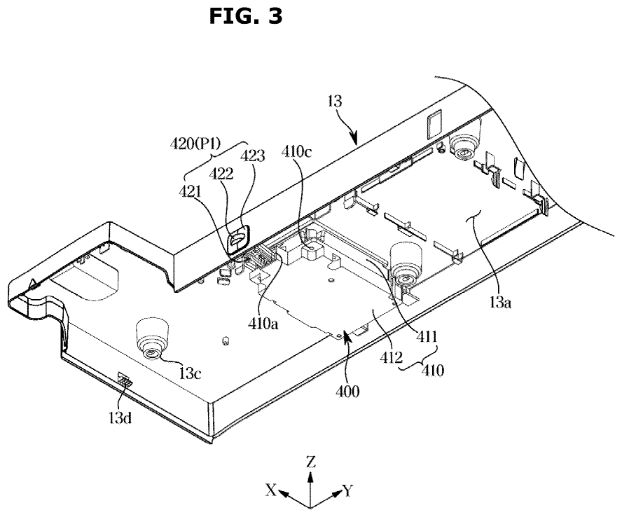

The top table 13 may cover various electrical components. An accommodating space 13a (refer to FIG. 3) in which various electrical components are accommodated may be formed in the top table 13. Particularly, the top table 13 may cover a door opening device 400, which will be described later, and the door opening device 400 may be accommodated in the top table 13. Accordingly, the top table 13 may be referred to as ‘door opening device cover 13’.

A detailed description of the structure of the top table 13 will be described later.

The configuration of the refrigerator 1 described above with reference to FIG. 1 is only an example for describing the refrigerator according to the present disclosure, and the present disclosure is not limited thereto. The refrigerator according to the present disclosure may be provided to include various configurations to perform the function of supplying cold air to the storage compartment for storing food.

The type of refrigerator, to which the refrigerator according to the present disclosure is applied, is not limited to the type of refrigerator 1 shown in the drawing, and the refrigerator according to the present disclosure may include various types of refrigerators such as side-by-side type, French door type, Bottom Mounted Freezer (BMF) type, Top Mounted Freezer (TMF) type or one-door type.

In addition, the refrigerator 1 according to one embodiment of the present disclosure is described on the assumption that the refrigerator is an indirect cooling type, but is not limited thereto. The present disclosure may be applied to a direct cooling type refrigerator.

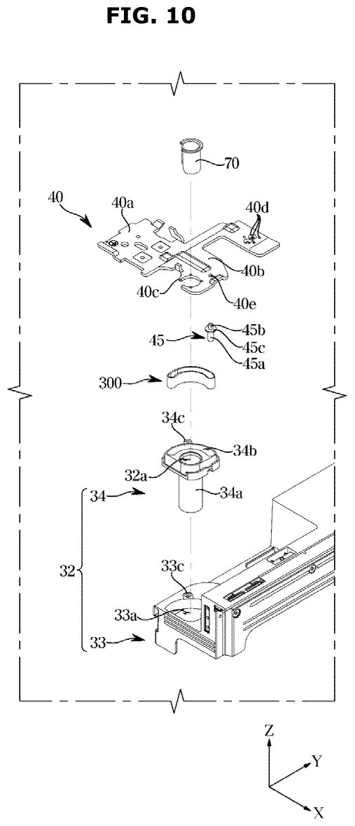

Hereinafter for convenience of description, the refrigerator according to the present disclosure will be described based on the refrigerator 1 according to one embodiment shown in FIGS. 1 to 23.

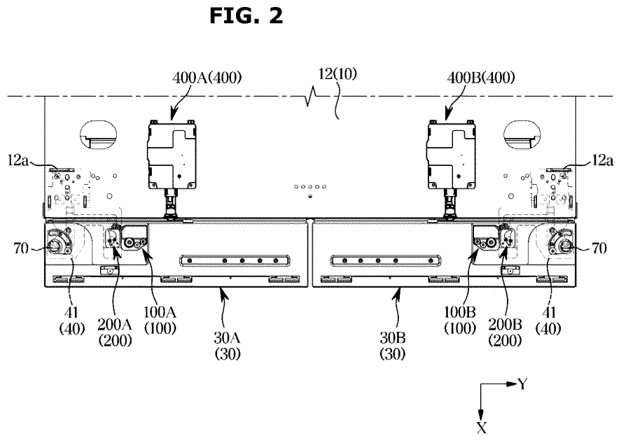

FIG. 2 is a top view illustrating a top table separated from the refrigerator according to one embodiment of the present disclosure.

Referring to FIG. 2, the refrigerator 1 according to one embodiment of the present disclosure may include the door opening device 400 configured to open the door 30.

The door opening device 400 may be configured to open the door 30. The door opening device 400 may be configured to rotate the door 30 with respect to the main body 10 to allow the storage compartment 20 to be opened.

Particularly, the door opening device 400 may be mounted on the main body 10. In a state in which the door opening device 400 is mounted on the main body 10, the door opening device 400 may open the door 30 by pressing the door 30 toward an opening direction. The door opening device 400 may be configured to press the door 30 based on receiving a door opening signal for opening the door 30.

The door opening device 400 may be configured to open the first storage compartment 21. That is, the refrigerator 1 may include a first door opening device 400A configured to open the first door 30A, and a second door opening device 400B configured to open the second door 30B.

Particularly, the first door opening device 400A may be configured to open the first door 30A. The first door opening device 400A may be configured to open the first door 30A based on receiving a first door opening signal for opening the first door 30A. The first door opening device 400A may be configured to open a portion of the first storage compartment 21 by rotating the first door 30A with respect to the main body 10.

Further, the second door opening device 400B may be configured to open the second door 30B. The second door opening device 400B may be configured to open the second door 30B based on receiving a second door opening signal for opening the second door 30B. The second door opening device 400B may be configured to open another portion of the first storage compartment 21 by rotating the second door 30B with respect to the main body 10.

The first door opening device 400A and the second door opening device 400B may be configured to open the first storage compartment 21 independently of each other.

In this case, the door opening device 400 may be mounted on the upper portion of the main body 10. Particularly, the door opening device 400 may be accommodated inside the top table 13. The upper portion of the door opening device 400 may be covered by the top table 13. The door opening device 400 may be disposed on the upper surface of the outer case 12.

The door opening device 400 may be mounted on the upper portion of the main body 10 so as to press the upper portion of the door 30. For example, the first door opening device 400A may be configured to press the upper portion of the first door 30A. Further, the second door opening device 400B may be configured to press the upper portion of the second door 30B.

However, the present disclosure is not limited thereto, and the door opening device 400 may be mounted in various positions of the main body 10 and configured to open the first storage compartment 21 by pressing various portions other than the upper portion of the first door 30A or the second door 30B.

For example, unlike FIG. 2, the door opening device 400 may be mounted on the horizontal partition 17 to press the lower portion of the first door 30A or the second door 30B.

Further, unlike FIG. 2, the door opening device 400 may be configured to open the second storage compartment 22. That is, the door opening device 400 may be configured to press the third door 30C based on receiving a third door opening signal for opening the second storage compartment 22. At this time, the door opening device 400 may be mounted on the lower portion of the main body 10 or on the horizontal partition 17.

Further, unlike FIG. 2, the door opening device 400 may be configured to open the third storage compartment 23. That is, the door opening device 400 may be configured to press the fourth door 30D based on receiving a fourth door opening signal for opening the third storage compartment 23. At this time, the door opening device 400 may be mounted on the lower portion of the main body 10 or on the horizontal partition 17.

Hereinafter for convenience of description, the door opening device 400 will be described based on an example in which the door opening device 400 is mounted to the upper portion of the main body 10 and configured to open the first storage compartment 21 by pressing the first door 30A or the second door 30B.

Hereinafter for convenience of description, the first door opening device 400A among the first door opening device 400A and the second door opening device 400B will be described as an example, and for convenience, the first door opening device 400A may be referred to as ‘door opening device 400’. Features of the door opening device 400 described below may be correspondingly applied to the second door opening device 400B.

Referring to FIG. 2, the refrigerator 1 according to one embodiment of the present disclosure may include a door opening and closing guide module configured to guide the opening and closing of the door 30.

Particularly, the refrigerator 1 may include a guide 200. The guide 200 may be provided to guide rotation of the door 30 while the door 30 is being opened or closed. In other words, the guide 200 may be provided to guide the door 30 to rotate in a specific direction according to the position of the door 30. In other words, the guide 200 may be provided to assist in opening or closing the door 30 according to the position of the door 30.

Particularly, the guide 200 may be provided to apply a force to the door 30 in the direction, in which the door 30 is opened or closed, according to the position of the door 30 while the door 30 is being opened or closed. Whether the door 30 receives a force in an opening direction or a closing direction by the guide 200 may vary according to the relative position of the door 30 with respect to the guide 200. That is, the guide 200 may guide the rotation of the door 30 to allow the door 30 to rotate in the opening direction when the door 30 is located at a specific position while the door 30 is being opened. Further, the guide 200 may guide the rotation of the door 30 to allow the door 30 to rotate in the closing direction when the door 30 is located at a specific position while the door 30 is being closed.

The guide 200 may be fixed to the main body 10. For example, the guide 200 may be coupled to the hinge bracket 40. As shown in FIG. 2, the guide 200 may be coupled to the upper door hinge bracket 41. Alternatively, the guide 200 may be formed integrally with the upper door hinge bracket 41.

The refrigerator 1 may include a lever device 100. The lever device 100 may be mounted on the door 30. As shown in FIG. 2, the lever device 100 may be mounted on the upper portion of the door 30.

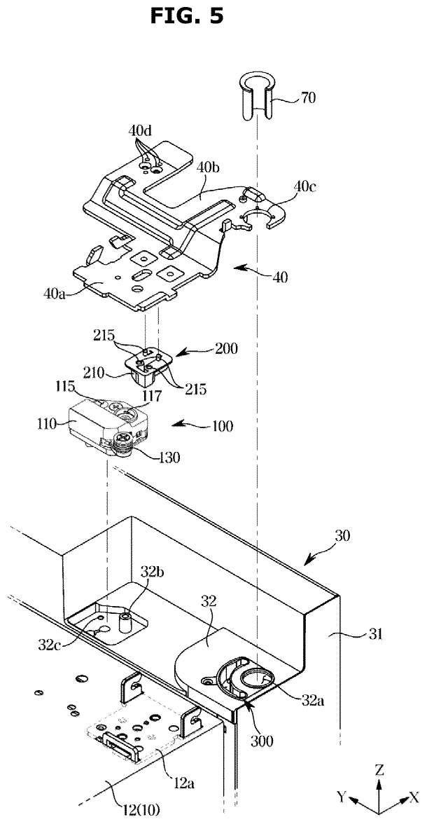

The lever device 100 may include a lever 130 (refer to FIG. 5, etc.) provided to be in contact with the guide 200 while the door 30 is being opened or closed. The lever device 100 may receive a force from the guide 200 when the lever 130 comes into contact with the guide 200. When the lever 130 is in contact with the guide 200, a force applied to the lever device 100 from the guide 200 may vary according to the relative position of the lever 130 with respect to the guide 200. ‘The force applied to the lever device 100 from the guide 200 varies’ means that a magnitude or direction of a force applied from the guide 200 to the lever device 100 may be changed according to the relative position of the lever 130 with respect to the guide 200. Accordingly, according to the relative position of the lever 130 with respect to the guide 200 when the lever 130 is in contact with the guide 200, the lever device 100 may transmit a force to the door 30 in the direction in which the door 30 is opened or transmit a force to the door 30 in the direction in which the door 30 is closed. In other words, according to the position of the door 30 while the door 30 is being opened or closed, the lever device 100 may transmit a force to the door 30 in the direction in which the door 30 is opened or transmit a force to the door 30 in the direction in which the door 30 is closed.

The door opening and closing guide module may be provided to guide the opening and closing of each of the first door 30A and the second door 30B.

Particularly, the refrigerator 1 may include a first guide 200A provided to guide the rotation of the first door 30A while the first door 30A is being opened or closed. According to the position of the first door 30A while the first door 30A is being opened or closed, the first guide 200A may be provided to apply a force to the first door 30A in the direction in which the first door 30A is opened or closed.

The first guide 200A may be fixed to the main body 10. For example, the first guide 200A may be coupled to the upper door hinge bracket 41 connected to the first door 30A among the pair of upper door hinge brackets 41. In other words, as shown in FIG. 2, the first guide 200A may be coupled to the upper door hinge bracket 41 disposed on the left side.

Further, the refrigerator 1 may include a first lever device 100A mounted on the first door 30A. For example, the first lever device 100A may be mounted on an upper portion of the first door 30A.

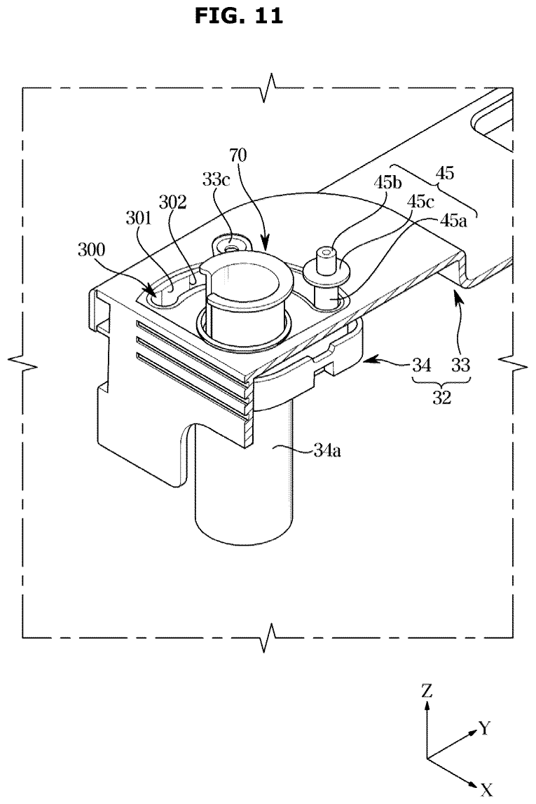

A lever 130 of the first lever device 100A (refer to FIG. 11) may be provided to be in contact with the first guide 200A while the first door 30A is being opened or closed. According to the position of the first door 30A while the first door 30A is being opened or closed, the first lever device 100A may be provided to apply a force to the first door 30A in the direction in which the first door 30A is opened or apply a force to the first door 30A in the direction in which the first door 30A is closed.

Further, the refrigerator 1 may include a second guide 200B provided to guide the rotation of the second door 30B while the second door 30B is being opened or closed. According to the position of the second door 30B while the second door 30B is being opened or closed, the second guide 200B may be provided to apply a force to the second door 30B in the direction in which the second door 30B is opened or closed.

The second guide 200B may be fixed to the main body 10. For example, the second guide 200B may be coupled to the upper door hinge bracket 41 connected to the second door 30B among the pair of upper door hinge brackets 41. In other words, as shown in FIG. 2, the second guide 200B may be coupled to the upper door hinge bracket 41 disposed on the right side.

Further, the refrigerator 1 may include a second lever device 100B mounted on the second door 30B. For example, the second lever device 100B may be mounted on an upper portion of the second door 30B.

A lever 130 of the second lever device 100B (refer to FIG. 5) may be provided to be in contact with the second guide 200B while the second door 30B is being opened or closed. According to the position of the second door 30B while the second door 30B is being opened or closed, the second lever device 100B may be provided to apply a force to the second door 30B in the direction in which the second door 30B is opened or apply a force to the second door 30B in the direction in which the second door 30B is closed.

However, the arrangement of the door opening and closing guide module, such as the lever device 100 and the guide 200, is not limited thereto.

For example, unlike FIG. 2, the lever device 100 may be mounted on the lower portion of the first door 30A or the second door 30B, and the guide 200 may be mounted on the intermediate hinge bracket 42.

For example, unlike FIG. 2, the guide 200 may be provided to guide the rotation of the third door 30C. The guide 200 may be provided to transmit a force to the third door 300C when the third door 30C rotates. At this time, the guide 200 may be disposed on the lower door hinge bracket 43 or the intermediate hinge bracket 42. Additionally, when the third door 30C rotates, the lever device 100 may be provided to be in contact with the guide 200 and may be provided to transmit a force to the third door 30C. At this time, the lever device 100 may be mounted on the lower or upper portion of the third door 30C to correspond to the position of the guide 200.

For example, unlike FIG. 2, the guide 200 may be provided to guide the rotation of the fourth door 30D. The guide 200 may be provided to transmit a force to the fourth door 30D when the fourth door 30D rotates. At this time, the guide 200 may be disposed on the lower door hinge bracket 43 or the intermediate hinge bracket 42. Additionally, when the fourth door 30D rotates, the lever device 100 may be provided to be in contact with the guide 200, and may be provided to transmit a force to the fourth door 30D. At this time, the lever device 100 may be mounted on the lower or upper portion of the fourth door 30D to correspond to the position of the guide 200.

Hereinafter for convenience of description, a configuration, in which the guide 200 is coupled to the upper door hinge bracket 41 and the lever device 100 is mounted on the upper portion of the first door 30A or the upper portion of the second door 30B so as to guide the rotation of the first door 30A or the second door 30B, will be described as an example.

Hereinafter for convenience of description, the first lever device 100A among the first lever device 100A and the second lever device 100B will be described as an example. For convenience, the first lever device 100A is referred to as ‘lever device 100’. Features of the lever device 100 described below may be correspondingly applied to the second lever device 100B.

Hereinafter for convenience of description, the first guide 200A among the first guide 200A and the second guide 200B will be described as an example, and for convenience, the first guide 200A will be referred to as ‘guide 200’. Features of the guide 200 described below may be correspondingly applied to the second guide 200B.

Hereinafter for convenience of description, the first door 30A among the plurality of doors 30A, 30B, 30C, and 30D will be described as an example, and for convenience, the first door 30A will be referred to as ‘door 30’.

Hereinafter for convenience of description, among the plurality of hinge brackets 41, 42, and 43, the upper door hinge bracket 41 connecting the first door 30A and the main body 10 will be described as an example. The upper door hinge bracket 41 may be referred to as ‘hinge bracket 40’.

Hereinafter among the partitioned storage compartments 21, 22, and 23, the first storage compartment 21 opened and closed by the first door 30A may be referred to as ‘storage compartment 20’.

The door 30 may be configured to be rotatable between an open position that maximally opens the storage compartment 20 and a closed position that closes the storage compartment 20. That is, the storage compartment 20 may be opened when the door 30 rotates from the closed position to the open position, and the storage compartment 20 may be closed when the door 30 rotates from the open position to the closed position. The open and closed positions of the door 30 may be defined as positions relative to the main body 10 and the storage compartment 20.

An opening angle of the door 30 may be defined as an angle by which the door 30 rotates from the closed position. That is, the opening angle of the door 30 may be defined as an angle by which the door 30 rotates from the closed position to the opening direction. As the opening angle of the door 30 increases, an extent to which the door 30 opens the storage compartment 20 may increase. The open position of the door 30 may be defined as the position of the door 30 when the opening angle of the door 30 is maximum.

For example, when the door 30 is in the open position, the opening angle of the door 30 may be approximately 80 degrees to 120 degrees.

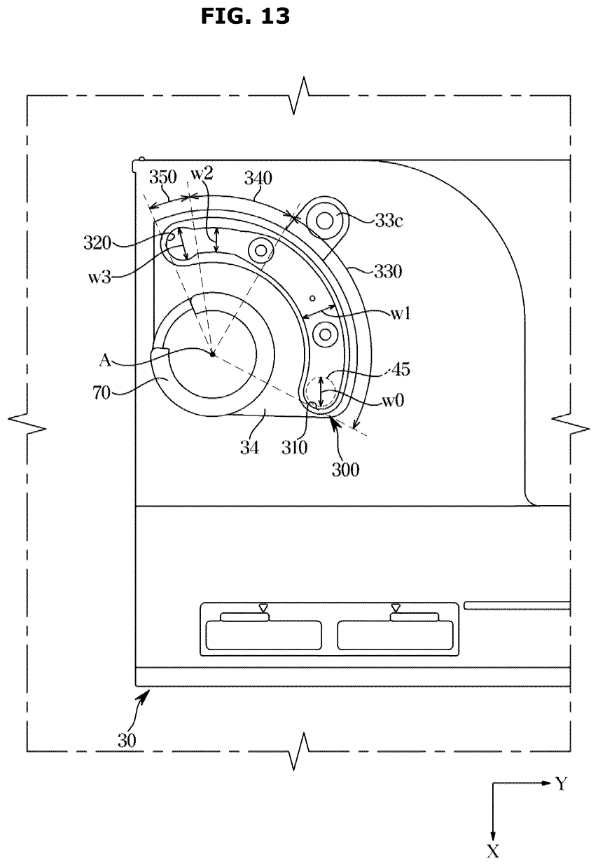

The door 30 may be configured to be rotatable about a rotation axis A (refer to FIG. 13) extending in one direction. For example, the door 30 may be configured to be rotatable about the rotation axis extending in the vertical direction (Z).

The rotation axis of the door 30 may be determined differently depending on the connection relationship between the door 30 and the main body 10. The rotation axis of the door 30 may pass through the door 30 and the hinge bracket 40. Accordingly, the door 30 may be rotatable relative to the hinge bracket 40 with respect to the rotation axis.

As illustrated in FIG. 2, when the hinge bracket 40 is fixed to the main body 10 and a portion, in which the door 30 and the hinge bracket 40 are connected to each other, is fixed to the main body 10, the rotation axis of the door 30 may be defined as an imaginary straight line fixed to the main body 10. That is, the door 30 may be configured to be rotatable between the open position and the closed position with respect to the rotation axis that is fixed to the main body 10.

However, when the hinge bracket 40 moves relative to the main body 10 and a portion, in which the door 30 and the hinge bracket 40 are connected to each other, moves relative to the main body 10 (e.g., a multiple-joint hinge type in which the hinge bracket includes a plurality of links rotatably connected to each other) when the door 30 opens or closes the storage compartment 20, the rotation axis of the door 30 may not be fixed to the main body 10.

The above-described door opening device 400 may be configured to rotate the door 30 from the closed position to the open position. The door opening device 400 may press the door 30 and rotate the door 30 toward the open position.

The above-described guide 200 may be provided to guide the rotation of the door 30 while the door 30 is being opened or closed. The guide 200 may apply a force to the door 30 while the door 30 is being opened or closed. While the door 30 is being opened, the magnitude or direction of force applied to the door 30 by the guide 200 may vary according to the opening angle of the door 30. Additionally, while the door 30 is being closed, the magnitude or direction of force applied to the door 30 by the guide 200 may vary according to the opening angle of the door 30.

The above-described lever device 100 may be mounted on the door 30 and may move together with the door 30 while the door 30 is being opened or closed. While the door 30 is being opened or closed, the lever device 100 may transmit a force to the door 30 by being in contact with the guide 200. The relative position of the lever device 100 with respect to the guide 200 may vary according to the opening angle of the door 30, and a point in which the lever 130 of the lever device 100 is in contact with the guide 200 may vary according to the opening angle of the door 30. A magnitude and direction of the force applied to the door 30 may vary according to a point in which the lever 130 of the lever device 100 is in contact with the guide 200.

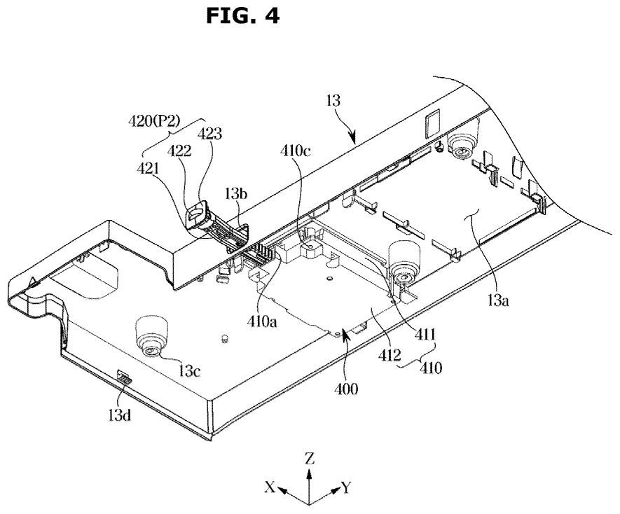

FIG. 3 is a view illustrating the top table and a door opening device of the refrigerator according to one embodiment of the present disclosure when a door pusher is located at a first pusher position. FIG. 4 is a view illustrating the top table and the door opening device of the refrigerator according to one embodiment of the present disclosure when the door pusher is located at a second pusher position.

Referring to FIGS. 3 and 4, the door opening device 400 of the refrigerator 1 according to one embodiment of the present disclosure may include a door pusher 420. The door pusher 420 may be configured to press the door 30 to open the door 30.

The door pusher 420 may be mounted on the main body 10. The door pusher 420 may be supported by a pusher case 410, which will be described later, and the pusher case 410 may be fixed to the main body 10. Accordingly, the door pusher 420 may be mounted on the main body 10 through the pusher case 410.

The door opening device 400 may include the pusher case 410 provided to support the door pusher 420. The pusher case 410 may accommodate at least a portion of the door pusher 420.

The pusher case 410 may be mounted on the main body 10. The pusher case 410 may be fixed to the main body 10.

For example, the pusher case 410 may be mounted on the top table 13. The pusher case 410 may include a fixing portion 410c coupled to the top table 13 and fixed to the main body 10. For example, the pusher case 410 may be fixed to the top table 13 by a fastening member (e.g., screw) that penetrates the fixing portion 410c.

The top table 13 may be fixed to the outer case 12. The top table 13 may include an outer case coupling portion provided to be fixed to the outer case 12. For example, the top table 13 may be fixed to the outer case 12 by screwing an outer case coupling portion 13c to one surface of the outer case 12 or the hinge bracket 40. Alternatively, the top table 13 may be fixed to the outer case 12 by hooking an outer case coupling portion 13d to the outer case 12 or the hinge bracket 40. As the top table 13 is fixed to the outer case 12, the door opening device 400 including the pusher case 410 may be stably mounted to the main body 10.

For example, the pusher case 410 may be covered by the top table 13. The pusher case 410 may be accommodated inside the top table 13. The top table 13 may be coupled to the inside of the top table 13. The top table 13 may include the accommodating space 13a provided to accommodate the door opening device 400, and the pusher case 410 may be disposed inside the accommodating space 13a.

For example, the pusher case 410 may include a first pusher case 411 and a second pusher case 412. The first pusher case 411 and the second pusher case 412 may be coupled to each other. Between the first pusher case 411 and the second pusher case 412, an accommodating space may be formed to accommodate various components of the door opening device 400, such as the door pusher 420.

The door pusher 420 may be configured to be movable with respect to the main body 10. The door pusher 420 may be configured to press the door 30 to the open position while moving relative to the main body 10. The door pusher 420 may be movably mounted on the main body 10.

The door pusher 420 may be movable in the pusher case 410. The pusher case 410 may movably support the door pusher 420. As the door pusher 420 is movably supported on the pusher case 410 and the pusher case 410 is fixed to the main body 10, the door pusher 420 may be mounted on the main body 10 and at the same time, the door pusher 420 may be movable relative to the main body 10.

The door pusher 420 may be movable with respect to the accommodating space 13a within the top table 13. The door pusher 420 may be inserted into the accommodating space 13a and accommodated within the accommodating space 13a, or may be withdrawn from the accommodating space 13a to press the door 30.

The top table 13 may include an opening 13b formed on one side of the accommodating space 13a. The door pusher 420 may be provided to penetrate the opening 13b and movable with respect to the accommodating space 13a. The opening 13b may be formed on one surface of the top table 13 facing the door 30 when the door 30 is in the closed position. For example, the opening 13b may be formed on the front surface of the top table 13.

The door pusher 420 may be movable between a first pusher position P1 and a second pusher position P2. Particularly, the door pusher 420 may be configured to perform reciprocating movement between the first pusher position P1 and the second pusher position P2.

The first pusher position P1 may be a position of the door pusher 420 when the door 30 is located in the closed position. The second pusher position P2 may be a position when the door pusher 420 moves from the first pusher position P1 to a direction of pressing the door 30. The door pusher 420 may move from the first pusher position P1 to the second pusher position P2 and press the closed door 30 so as to open the closed door 30. Based on the drawings, the second pusher position P2 may be a position in which the door pusher 420 moves forward from the first pusher position P1.

The door pusher 420 may be accommodated in the accommodating space 13a of the top table 13 when the door pusher 420 is positioned in the first pusher position P1. That is, the door pusher 420 may be in a state of being inserted into the accommodating space 13a of the top table 13 when the door pusher 420 is positioned at the first pusher position P1. The door pusher 420 may be withdrawn from the accommodating space 13a and moved from the first pusher position P1 to the second pusher position P2. While the door pusher 420 penetrates the opening 13b of the top table 13, the door pusher 420 may be movable between the first pusher position P1 and the second pusher position P2.

For example, as shown in FIGS. 3 and 4, the door pusher 420 may be provided to be linearly movable between the first pusher position P1 and the second pusher position P2. As shown in the drawing, the door pusher 420 may be configured to move linearly in the front and rear direction (X). However, the door pusher 420 may move non-linearly between the first pusher position P1 and the second pusher position P2.

The door pusher 420 may move from the first pusher position P1 to the second pusher position P2 based on receiving a door opening signal. The door opening signal may include a user input that is received through an input button and that is for opening the door 30.

The door pusher 420 may be configured to press the door 30 until the door pusher 420 reaches the second pusher position P2. Thereafter, based on reaching the second pusher position P2, the door pusher 420 may stop moving or move to the first pusher position P1. In this case, the door pusher 420 may no longer press the door 30.

The door pusher 420 may include a movable rod 421 configured to be movable with respect to the main body 10. The movable rod 421 may be configured to be movable with respect to the pusher case 410. The movable rod 421 may be supported on the pusher case 410. At least a portion of the movable rod 421 may be accommodated in the pusher case 410. The movable rod 421 may be provided to be movable with respect to the accommodating space 13a of the top table 13. At least a portion of the movable rod 421 may be accommodated in the accommodating space 13a. The movable rod 421 may be inserted into or withdrawn from the accommodating space 13a.

For example, the movable rod 421 may be configured to move linearly with respect to the main body 10. The movable rod 421 may be configured to move linearly with respect to the pusher case 410.

The door pusher 420 may include a push roller 422. The push roller 422 may be mounted on one side of the movable rod 421 with respect to the direction of pressing the door 30. When the door pusher 420 moves from the first pusher position P1 to the second pusher position P2, the push roller 422 may be in contact with the door 30. That is, the door 30 may be pressed by the push roller 422.

It is possible to allow the push roller 422 to be rotatable with respect to the movable rod 421. The push roller 422 may be configured to be rotatable with respect to the movable rod 421.

The door pusher 420 may include an opening cover 423 disposed on one side of the movable rod 421. The opening cover 423 may be provided to cover the opening 13b of the top table 13 when the door pusher 420 is located in the first pusher position P1. The opening cover 423 may be provided to seal a gap between the door pusher 420 and the opening 13b when the door pusher 420 is located in the first pusher position P1.

As mentioned above, the door opening device 400 may open the door 30 by including the door pusher 420 configured to be movable with respect to the main body 10 and configured to press the door 30.

FIG. 5 is a view illustrating a partial configuration of the refrigerator according to one embodiment of the present disclosure.

Referring to FIG. 5, a portion of the hinge bracket 40 included in the refrigerator 1 according to one embodiment of the present disclosure may be fixed to the main body 10, and the other portion thereof may rotatably support the door 30.

Particularly, the hinge bracket 40 may include a body fixing portion 40a fixed to the main body 10 and a door support portion 40b supporting the door 30. The body fixing portion 40a and the door support portion 40b may be connected to each other. The door support portion 40b may be formed to extend from the body fixing portion 40a toward the door 30. For example, the body fixing portion 40a and the door support portion 40b may be formed integrally with each other.

For example, the body fixing portion 40a may be coupled to the outer case 12. The body fixing portion 40a may be seated on one surface of the outer case 12. For example, the main body 10 may include a hinge bracket coupling member 12a coupled to the outer case 12. The body fixing portion 40a may be coupled to the outer case 12 by being fitted and coupled to the hinge bracket coupling member 12a. Alternatively, the body fixing portion 40a may be coupled to the outer case 12 by being fastened to the hinge bracket coupling member 12a through a screw.

For example, the door support portion 40b may be disposed on one side of the door 30. On one side of the door 30, the door support portion 40b may be disposed adjacent to the rotation axis of the door 30. The door support portion 40b may rotatably support the door 30.

The refrigerator 1 may include a hinge shaft 70 coupled to the door 30 and the hinge bracket 40. The hinge shaft 70 may pass through the rotation axis of the door 30. The hinge bracket 40 may include a hinge shaft coupling portion 40c to which the hinge shaft 70 is coupled. The hinge shaft coupling portion 40c may be disposed on the door support portion 40b.

For example, the hinge shaft 70 may be formed to have a substantially cylindrical shape having a central axis corresponding to the rotation axis of the door 30.

For example, the hinge shaft 70 may be fixed to the hinge shaft coupling portion 40c of the door support portion 40b, and the door 30 may be rotatable about the hinge shaft 70. The hinge shaft 70 may be inserted into one side of the door 30. The door 30 may include a shaft hole 32a into which the hinge shaft 70 is inserted, and the shaft hole 32a may be formed on one surface of the door 30 facing the hinge bracket 40.

For example, the hinge shaft coupling portion 40c may be formed to allow the hinge shaft 70 to penetrate therethrough. The hinge shaft 70 may be fitted into the hinge shaft coupling portion 40c while being disposed to penetrate the hinge shaft coupling portion 40c. The hinge shaft coupling portion 40c may be disposed at a position corresponding to the shaft hole 32a.

The door 30 may include a door frame 31 and a door cap 32 coupled to the door frame 31. The door frame 31 and the door cap 32 may each form the exterior of the door 30. The door frame 31 may be formed along an edge of the door 30 and may form an appearance of a left edge and an appearance of a right edge of the door 30. The door cap 32 may be provided as a pair and may be coupled to upper and lower portions of the door frame 31, respectively. The pair of door caps 32 may form the appearance of the left edge and the appearance of the right edge of the door 30. FIG. 5 illustrates the door cap 32 provided on the upper portion of the door 30 among the pair of door caps 32 as an example.

For example, the door support portion 40b of the hinge bracket 40 may be provided to support the door cap 32 of the door 30. The shaft hole 32a may be formed in the door cap 32, and the hinge shaft 70 may pass through the shaft hole 32a formed in the door cap 32 so as to connect the hinge bracket 40 and the door 30.

The guide 200 may be coupled to the hinge bracket 40. The guide 200 may be fixed to the main body 10 by being fixed to the hinge bracket 40. For example, the guide 200 may be fixed to the body fixing portion 40a of the hinge bracket 40.

As shown in FIG. 5, the hinge bracket 40 may include a guide coupling portion 40d to which the guide 200 is coupled so as to support the guide 200. The guide 200 may include a hinge bracket coupling portion 215 coupled to the guide coupling portion 40d. For example, the guide 200 may be fastened to the hinge bracket 40 by a screw penetrating the guide coupling portion 40d and the hinge bracket coupling portion 215. For example, the hinge bracket coupling portion 215 of the guide 200 may have a protrusion shape that penetrates the guide coupling portion 40d. As the hinge bracket coupling portion 215 penetrates the guide coupling portion 40d, the guide 200 may be coupled to the hinge bracket 40. However, the method by which the guide 200 is fixed to the hinge bracket 40 is not limited thereto.

When the guide 200 is coupled to the hinge bracket 40 as mentioned above, the guide 200 may have a fixed position with respect to the main body 10 while being located in a position away from the main body 10. That is, as the guide 200 is coupled to the hinge bracket 40, the guide 200 may be positioned closer to the door 30 and fixed to the main body 10. As a result, the guide 200 may have a simple structure and may apply a force to the door 30 (or the lever device 100 mounted on the door 30) when the door 30 rotates.

The lever device 100 may be mounted on the door 30. Particularly, the lever device 100 may be mounted on one side of the door 30 adjacent to the hinge bracket 40.

The lever device 100 may be coupled to the door cap 32. For example, a lever device coupling protrusion 32b may be provided on one side of the door cap 32, and the lever device coupling protrusion 32b may be inserted into an insertion hole 117 formed in the lever device 100 to fix the lever device 100. For example, a lever device coupling hole 32c may be formed on one side of the door cap 32, and a coupling hole 115 corresponding to the lever device coupling hole 32c may be formed in the lever device 100. Accordingly, the lever device 100 may be coupled to the door cap 32 by a fastening member (e.g., screw) penetrating the coupling hole 115 and the lever device coupling hole 32c. However, the structure in which the lever device 100 is mounted on the door 30 is not limited thereto.

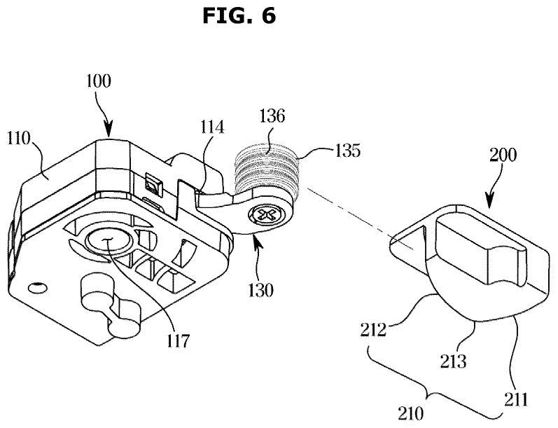

FIG. 6 is a view illustrating a lever device and a guide of the refrigerator according to one embodiment of the present disclosure.

Referring to FIG. 6, the refrigerator 1 may include the lever device 100 and the guide 200. The lever device 100 and the guide 200 may form the door opening and closing guide module configured to apply a force to the door 30 and guide the rotation of the door 30 when the door 30 rotates.

The lever device 100 may be configured to receive a force from the guide 200 and transmit the force to the door 30 when the door 30 rotates. For example, when the door 30 rotates to the open position, the lever device 100 may receive a force from the guide 200 and transmit the force to the door 30 in the direction in which the door 30 is opened. For example, when the door 30 rotates to the closed position, the lever device 100 may be in contact with the guide 200 and transmit the force to the door 30 in the direction in which the door 30 is closed.

Particularly, the lever device 100 may include the lever 130 provided to be in contact with the guide 200. The guide 200 may be provided to guide the movement of the lever 130 by being in contact with the lever 130 when the door 30 rotates. Because the guide 200 is fixed to the main body 10 and the lever 130 is mounted on the door 30, the relative position of the lever 130 with respect to the guide 200 may be changed according to the position of the door 30. That is, the position of the lever 130 in contact with the guide 200 may vary according to the opening angle of the door 30. The guide 200 may have a cam structure that guides the movement of the lever 130.

The lever 130 may include a roller 135 provided to be in contact with the guide 200. The roller 135 may be provided to be in contact with a guide surface 210 when the door 30 rotates. The roller 135 in contact with the guide surface 210 may move along the shape of the guide surface 210.

For example, the roller 135 may be rotatably mounted to the lever 130.

For example, the roller 135 may include a plurality of grooves 136 formed along an outer circumferential surface of the roller 135. When the roller 135 is in contact with the guide surface 210, a contact area between the roller 135 and the guide surface 210 may be reduced because the plurality of grooves 136 is formed on the outer circumferential surface of the roller 135. Accordingly, friction between the roller 135 and the guide surface 210 may be reduced.

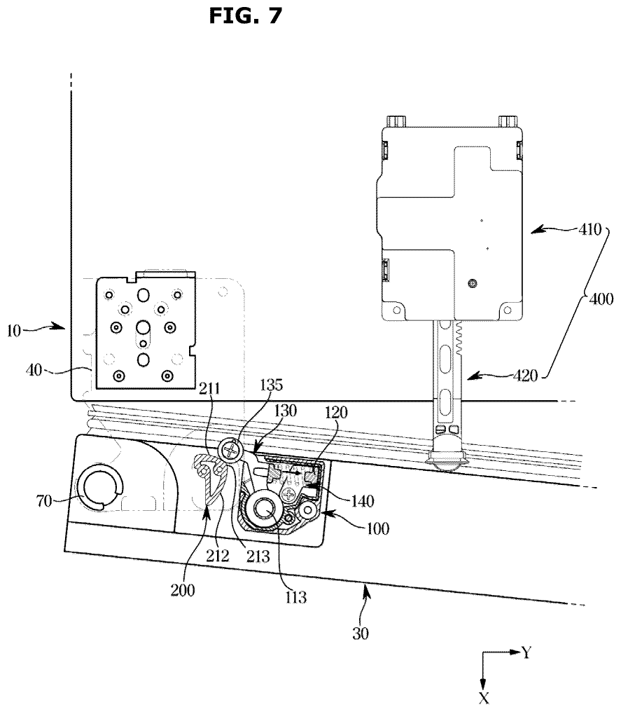

For example, the lever 130 may be configured to be movable relative to the door 30. Particularly, the lever 130 may be rotatable relative to the door 30 with respect to a lever shaft 113 (refer to FIG. 7).

The lever device 100 may include a lever case 110. The lever case 110 may be fixed to the door 30. For example, the lever case 110 may be mounted on the door cap 32. The lever case 110 may form the exterior of the lever device 100. The lever case 110 may support each component of the lever device 100, such as the lever 130 and a spring 140 (refer to FIG. 7).

The lever case 110 may include the lever shaft 113 (refer to FIG. 7) to which the lever 130 is rotatably coupled. The lever 130 may be rotatably coupled to the lever shaft 113 and may rotate relative to the lever case 110 with respect to the lever shaft 113. For example, the lever 130 may be configured to be rotatable with respect to the lever shaft 113 when the lever 130 is in contact with the guide 200 while the door 30 rotates.

For example, the lever shaft 113 may have a cylindrical shape having a central axis corresponding to the rotation axis of the lever 130.

The lever case 110 may include a lever opening 114 provided to open to allow the lever 130 to rotate about the lever shaft 113. The lever opening 114 may be formed to prevent the lever 130 from interfering with the lever case 110 when the lever 130 rotates about the lever shaft 113. The lever opening 114 may form a space to allow the lever 130 to rotate about the lever shaft 113. A portion of the lever 130 accommodated inside the lever case 110 may be exposed to the outside of the lever case 110 through the lever opening 114.

The lever case 110 may include the coupling hole 115 corresponding to the lever device coupling hole 32c of the door cap 32.

The lever case 110 may include the insertion hole 117 into which the lever device coupling protrusion 32b of the door cap 32 is inserted. As the lever device coupling protrusion 32b is inserted into the insertion hole 117, the lever device 100 may be fixed to the door cap 32.

The guide 200 may include the guide surface 210 provided to be in contact with the lever 130 while the door 30 is being opened or closed. The guide surface 210 may form a portion of the outer surface of the guide 200.

Particularly, the guide surface 210 may include a first contact surface 211 provided to apply a force to the lever 130 in the direction, in which the door 30 is closed, by being in contact with the lever 130. When the lever 130 is in contact with the first contact surface 211, the lever 130 may apply a force to the door 30 in the direction in which the door 30 is closed. When the lever 130 comes into contact with the first contact surface 211 while the door 30 is being closed, the lever 130 may apply a force to the door 30 in the direction in which the door 30 is closed. At this time, the lever 130 may move along the first contact surface 211.

In addition, the guide surface 210 may include a second contact surface 212 provided to transmit a force in the direction, in which the door 30 is opened, to the lever 130, by being in contact with the lever 130. When the lever 130 is in contact with the second contact surface 212 of the guide 200, the lever 130 may apply a force to the door 30 in the direction in which the door 30 is opened. When the lever 130 comes into contact with the second contact surface 212 while the door 30 rotates from the closed position to the open position, the lever 130 may apply a force to the door 30 in the direction in which the door 30 is opened. At this time, the lever 130 may move along the second contact surface 212.

The guide surface 210 may include a curved point 213 disposed between the first contact surface 211 and the second contact surface 212. The first contact surface 211 and the second contact surface 212 may be connected to each other based on the curved point 213. While the door 30 is being opened, the lever 130 in contact with the guide 200 may move by sequentially passing the first contact surface 211, the curved point 213, and the second contact surface 212. While the door 30 is being closed, the lever 130 in contact with the guide 200 may move by sequentially passing the second contact surface 212, the curved point 213, and the first contact surface 211. That is, as the opening angle of the door 30 increases, the lever 130 may move while being sequentially in contact with the first contact surface 211, the curved point 213, and the second contact surface 212. Conversely, as the opening angle of the door 30 decreases, the lever 130 may move while being sequentially in contact with the second contact surface 212, the curved point 213, and the first contact surface 211.

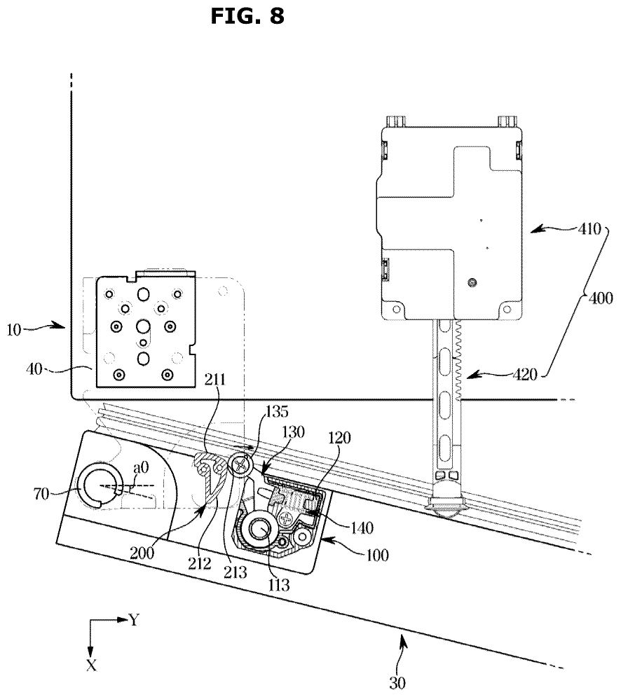

An opening angle of the door 30 when the lever 130 is in contact with the curved point 213 of the guide 200 is defined as a reference angle a0 (refer to FIG. 8).

When the opening angle of the door 30 is less than the reference angle a0, the lever 130 may be in contact with the first contact surface 211 of the guide 200. In this case, the lever 130 may apply a force to the door 30 in the direction in which the door 30 is closed. Through the lever 130, the guide 200 may apply a force to the door 30 in the direction in which the door 30 is closed. When an additional external force is not applied to the door 30 in the state in which the lever 130 is in contact with the first contact surface 211, the door 30 may be closed. When a force greater than the force applied by the guide 200 and the lever 130 is transmitted to the door 30 in the direction of opening the door 30, the door 30 may rotate to the open position despite of the lever 130 and the guide 200.

Conversely, when the opening angle of the door 30 is greater than the reference angle a0, the lever 130 may be in contact with the second contact surface 212 of the guide 200. In this case, the lever 130 may apply a force to the door 30 in the direction in which the door 30 is opened. Through the lever 130, the guide 200 may apply a force to the door 30 in the direction in which the door 30 is opened. When an additional external force is not applied to the door 30 in the state in which the lever 130 is in contact with the second contact surface 212, the door 30 may be opened. When a force greater than the force applied by the guide 200 and the lever 130 is transmitted to the door 30 in the direction of closing the door 30, the door 30 may rotate to the closed position.

With this structure, the guide 200 and the lever device 100 may transmit a force to the door 30 in the direction in which the door 30 is closed while the door 30 is being closed. That is, the guide 200 and the lever device 100 may allow the door 30 to close when the door 30 is closed at a certain angle or more. In addition, while the door 30 being is opened, the guide 200 and the lever device 100 may apply a force to the door 30 in the direction in which the door 30 is opened.

A force which is applied to the door 30 when the guide 200 is in contact with the lever 130 may include an elastic force caused by the lever 130. Particularly, the lever device 100 may include the spring 140 (refer to FIG. 7) connected to the lever 130. The spring 140 may elastically support the lever 130. For example, the spring 140 may include a compression spring.

According to a position in which the lever 130 is in contact with the guide 200, the spring 140 may accumulate an elastic force or provide an elastic force to the door 30. The spring 140 may be provided to be compressed or stretched according to the position in which the lever 130 is in contact with the guide 200. The lever 130 may provide an elastic force to the door 30 using the spring 140.

One end of the spring 140 may be maintained in a fixed position relative to the lever case 110 and the other end of the spring 140 may be connected to the lever 130. The spring 140 may support the lever 130 to allow the lever 130 to elastically move. Because one end of the spring 140 is maintained in the fixed position relative to the lever case 110 and the other end of the spring 140 is connected to the lever 130 when the lever 130 rotates according to the opening and closing of the door 30, the spring 140 may be compressed by the lever 130 that rotates relative to the lever case 110 or the length of the spring may be returned to before the compression. When the lever 130 rotates about the lever shaft 113, the spring 140 may be compressed or returned to the original length before the compression, according to the rotation direction of the lever 130. When the spring 140 is compressed by the lever 130, the spring 140 may accumulate the elastic force as much as the spring 140 is compressed, and when the compressed spring 140 is returned to the length before the compression, the spring 140 may provide the accumulated elastic force to the door 30. As the lever 130 rotates with respect to the lever shaft 113 by being in contact with the guide surface 210 while the door 30 rotates, the lever 130 may compress the spring 140 or allow the spring 140 to be returned to the length before the compression.

For example, the lever device 100 may include a support 120 provided to support the spring 140 (refer to FIG. 7). The support 120 may be provided to support one end of the spring 140. In the lever case 110, both ends of the spring 140 may be supported by the support 120 and the lever 130, respectively. The support 120 may be mounted to the inside of the lever case 110. The support 120 may be fixed to the lever case 110. Alternatively, one end of the spring 140 may be fixed to a portion other than the support 120 as long as the spring 140 is provided to be fixed when the lever 130 rotates.

With this structure, the lever 130 may rotate about the lever shaft 113 when the lever 130 moves along the guide surface 210 of the guide 200. When the lever 130 rotates about the lever shaft 113, the roller 135 may move while maintaining contact with the guide surface 210 due to the elastic force of the spring 140. When the lever 130 rotates about the lever shaft 113, the roller 135 may move while maintaining contact with the guide surface 210. Accordingly, the spring 140 may be compressed more efficiently and accumulate the elastic force and when the spring 140 is returned to the length before the compression, the elastic force of the spring 140 may be more efficiently provided to the door 30. The spring 140 may be compressed or returned when the roller 135 moves along the guide surface 210 while the roller 135 is in contact with the guide surface 210.

According to the position in which the lever 130 is in contact with the guide 200, the relative position of the lever 130 with respect to the door 30 may vary, and the spring 140 may be compressed or stretched.

When the lever 130 is in contact with the first contact surface 211 of the guide 200, the spring 140 may provide an elastic force to the door 30 in the direction in which the door 30 is closed. When the lever 130 is in contact with the second contact surface 212 of the guide 200, the spring 140 may provide an elastic force to the door 30 in the direction in which the door 30 is opened. When the lever 130 is in contact with the curved point 213 located between the first contact surface 211 and the second contact surface 212, the elastic force may be maximally accumulated in the spring 140.

The guide surface 210 may have a shape that protrudes toward the lever 130 when the lever 130 is in a position in contact with the guide surface 210. The guide surface 210 may be formed to maximally protrude at the curved point 213.

As shown in FIGS. 7 to 9, etc., a distance from the rotation axis of the door 30 in the horizontal direction (left and right direction (Y)) may be the furthest from the curved point 213 among regions on the guide surface 210. The first contact surface 211 and the second contact surface 212 may be extended in such a way that as the first contact surface 211 and the second contact surface 212 are away from the curved point 213, the distance in the horizontal direction (Y) from the rotation axis of the door 30 may be reduced. That is, the first contact surface 211 and the second contact surface 212 of the guide surface 210 may be formed to be inclined in a direction opposite to the direction in which the guide surface 210 protrudes based on the curved point 213.

With this configuration, the elastic force may be maximally accumulated in the spring 140 when the lever 130 is in contact with the curved point 213, and when the lever 130 moves from the position in contact with the curved point 213 to the first contact surface 211 or the second contact surface 212, the spring 140 may be returned and the accumulated elastic force may be applied to the door 30. The curved point 213 may be a reference point at which the elastic force accumulated in the spring 140 is applied to the door 30.

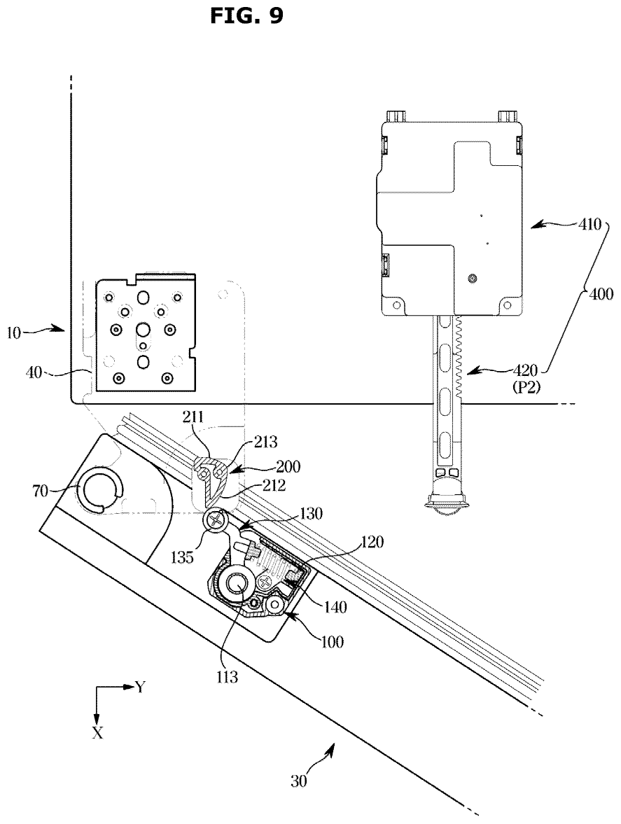

FIG. 7 is a view illustrating a state in which the door pusher presses the door when a roller of the lever is in contact with a first contact surface of the guide in the refrigerator according to one embodiment of the present disclosure. FIG. 8 is a view illustrating a state in which the door pusher presses the door when the roller of the lever is in contact with a curved point of the guide in the refrigerator according to one embodiment of the present disclosure. FIG. 9 is a view illustrating a state in which the door pusher in a stopped state when the roller of the lever is in contact with a second contact surface of the guide in the refrigerator according to one embodiment of the present disclosure.

Referring to FIGS. 7 to 9, as the door pusher 420 of the door opening device 400 of the refrigerator 1 according to one embodiment of the present disclosure presses the door 30 while the door pusher 420 moves from the first pusher position P1 (refer to FIG. 3) to the second pusher position P2, the door 30 may be opened.

As illustrated in FIG. 7, when the opening angle of the door 30 is less than the reference angle a0 (refer to FIG. 8), the guide 200 may transmit a force to the door 30 in the direction in which the door 30 is closed. Particularly, when the opening angle of the door 30 is less than the reference angle a0, the lever 130 of the lever device 100 may be in contact with the first contact surface 211 of the guide 200, and the lever 130 in contact with the first contact surface 211 of the guide 200 may apply a force to the door 30 in the direction in which the door 30 is closed. While the door 30 is being opened, the lever 130 in contact with the first contact surface 211 may press the spring 140, and the elastic force may be accumulated in the spring 140.

As shown in FIG. 8, when the door 30 reaches a position that is rotated by the reference angle a0 from the closed position to the open position, the lever 130 may be in contact with the curved point 213 of the guide 200, and the spring 140 may be maximally compressed.

While the door 30 is being opened, the door pusher 420 may press the door 30 until the opening angle of the door 30 is greater than the reference angle a0.

As illustrated in FIG. 9, when the opening angle of the door 30 is greater than the reference angle a0, the guide 200 may apply a force to the door 30 in the direction in which the door 30 is opened. When the opening angle of the door 30 is greater than the reference angle a0, the lever 130 of the lever device 100 may be in contact with the second contact surface 212 of the guide 200, and the elastic force accumulated in the spring 140 may be applied to the door 30 through the guide 200 and the lever 130. Accordingly, the door 30 may be opened.

Therefore, when the door pusher 420 moves to the second pusher position P2 and presses the door 30 until the opening angle of the door 30 is greater than the reference angle a0, the opening angle of the door 30 may continue to increase although the door pusher 420 stops at the second pusher position P2. Accordingly, the door 30 may more easily rotate to the open position.

The reference angle a0 of the door 30 may vary according to the shape of the guide surface 210. The second pusher position P2 of the door pusher 420 may vary according to the reference angle a0, the width of the door 30, and the distance in the horizontal direction (Y) between the point, at with the door pusher 420 presses the door 30, and the rotation axis of the door 30. In other words, the moving distance of the door pusher 420 or the withdrawal distance of the door pusher 420 may vary according to the reference angle a0, the width of the door 30, and the distance in the horizontal direction (Y) between the point, at with the door pusher 420 presses the door 30, and the rotation axis of the door 30.

When an opening angle of the door 30 when the door pusher 420 is located at the second pusher position P2 is referred to as ‘first angle’, the door pusher 420 may press the door 30 until the door 30 reaches a position rotated by the first angle from the closed position to the open position. The door opening device 400 may open the door 30 until the opening angle of the door 30 reaches the firs angle. The first angle may be greater than or equal to the reference angle a0.

When the door 30 is in a range between the first angle and a second angle (second angle is greater than the first angle), the guide 200 may apply a force the door 30 in the direction in which the door 30 is opened. The second angle may mean an opening angle of the door 30 at a point of time when the lever 130 is separated from the second contact surface 212 as the opening angle of the door 30 increases.

When the opening angle of the door 30 is greater than the second angle, the lever 130 may be separated from the second contact surface 212 and the door 30 may not receive a force from the lever 130. Even in this case, the door 30 that is being opened may continue to be opened due to the inertia. Accordingly, the door 30 may be fully opened even without the application of the additional external force.

With this structure, the door 30 may be opened automatically and may easily rotate to a fully opened position without stopping in the opening process.

However, in this configuration, it may be required to stop the door 30 when the door 30 reaches the maximum open position. That is, a structure that guides the position of the door 30 while the door 30 is being opened and that maintains a constant opening angle when the door 30 is fully opened may be required. Particularly, the inertia of the door 30 may change due to reasons such as the change in the overall weight of the door 30 due to food stored in the door basket 36, etc., and thus the rotation speed or the rotation angle of the door 30 that is being opened by the door opening device 400, the guide 200, the lever device 100, etc. may change. Accordingly, the above-mentioned structure may be further required.

In addition, when the door 30 is opened at an excessively high speed, excessive load may be generated on the door 30, the hinge shaft 70, and the hinge bracket 40, or the door 30 may collide with an external structure. Accordingly, there is a possibility that the product may be damaged due to such reasons. Therefore, it may be required to limit the rotation speed of the door 30 while the door 30 is being opened.

Therefore, the refrigerator 1 according to one embodiment of the present disclosure may include a guide rail 300 and a guide shaft 45 for guiding the rotation of the door 30.

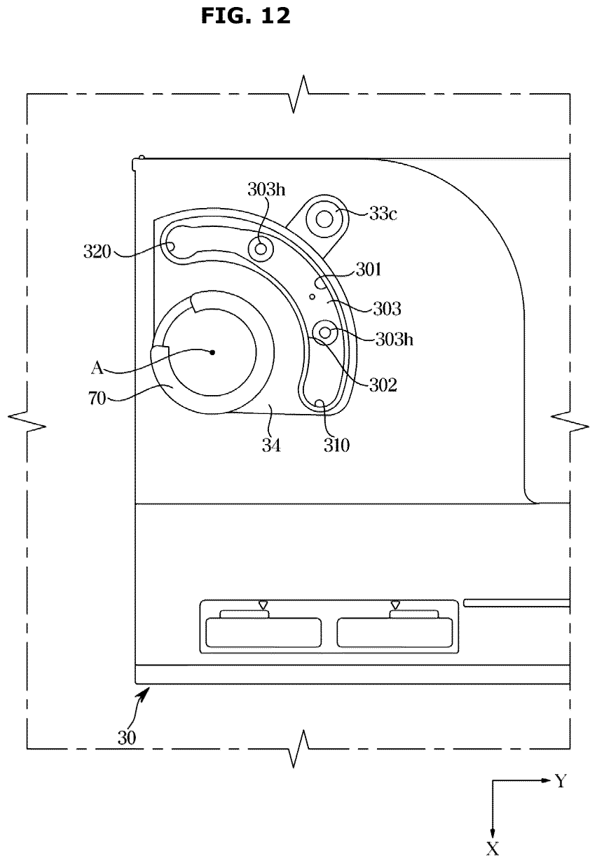

FIG. 11 is a view illustrating some configurations of the refrigerator according to one embodiment of the present disclosure. FIG. 12 is a view illustrating the configuration of the door, a shaft coupling member, a hinge shaft, and a guide rail of the refrigerator according to one embodiment of the present disclosure. FIG. 13 is a view illustrating the guide rail and a guide shaft when the door of the refrigerator according to one embodiment of the present disclosure is located in a closed position.

Referring to FIGS. 11 to 13, the refrigerator 1 according to one embodiment of the present disclosure may include the guide rail 300 provided on the door 30. The door 30 may include the guide rail 300.

The guide rail 300 may be provided to be rotatable about the rotation axis A of the door 30. While the door 30 is being opened or closed, the guide rail 300 may also rotate about the rotation axis A of the door 30. The guide rail 300 may be arranged to be spaced apart from the rotation axis of the door 30. For example, the guide rail 300 may be arranged to be spaced apart from the hinge shaft 70.

For example, the guide rail 300 may be mounted on the door cap 32. The guide rail 300 may be fixed to the door cap 32.

The door cap 32 may include a cap body 33 and a shaft coupling member 34. The shaft coupling member 34 may be coupled to the cap body 33. The cap body 33 and the shaft coupling member 34 may be fixed to each other.

The cap body 33 may form the upper exterior of the door 30. For example, the lever device 100 described above may be coupled to the cap body 33.

The shaft coupling member 34 may be provided to allow the hinge shaft 70 to be coupled thereto. The shaft coupling member 34 may be provided to support the hinge shaft 70. For example, the hinge shaft 70 may be arranged to penetrate the shaft coupling member 34. The shaft coupling member 34 may be fixed to the cap body 33 and rotatable about the hinge shaft 70. The aforementioned shaft hole 32a may be formed in the shaft coupling member 34. For example, the shaft hole 32a may be formed on an upper surface of the shaft coupling member 34.

For example, the shaft coupling member 34 may include a shaft accommodating portion 34a provided to accommodate the hinge shaft 70. The shaft accommodating portion 34a may be provided to accommodate at least a portion of the hinge shaft 70. The shaft hole 32a may be formed by the shaft accommodating portion 34a. A separation space may be formed between an inner circumferential surface of the shaft accommodating portion 34a and an outer circumferential surface of the hinge shaft 70. Accordingly, the shaft coupling member 34 may be provided to rotate about the hinge shaft 70 accommodated in the shaft accommodating portion 34a.

For example, the shaft accommodating portion 34a may be formed in a substantially hollow cylindrical shape.

For example, the shaft coupling member 34 may be formed of a material containing Acrylonitrile Butadiene Styrene (ABS) resin.

The cap body 33 may include a coupling portion 33a to which the shaft coupling member 34 is coupled. For example, the coupling portion 33a may be formed in the shape of a hole that is formed in such a way that a portion of the cap body 33 is penetrated. The shaft coupling member 34 may be arranged to penetrate the coupling portion 33a of the cap body 33. In the state in which the shaft coupling member 34 penetrates the coupling portion 33a of the cap body 33, the shaft coupling member 34 may be in contact with the cap body 33 and then supported by the cap body 33.

For example, the cap body 33 and the shaft coupling member 34 may be fastened to each other by a fastening member (not shown). The cap body 33 and the shaft coupling member 34 may be fastened to each other by a fastening member (e.g. screw) that sequentially penetrates a fastening portion 33c of the cap body 33 and a fastening portion 34c of the shaft coupling member 34. For example, the fastening portion 34c of the shaft coupling member 34 may be arranged to be in contact the fastening portion 33c of the cap body 33 from the lower side, and the fastening member may sequentially penetrate the fastening portion 33c of the cap body 33 and the fastening portion 34c of the shaft coupling member 34 with the respect to a direction from top to bottom.

However, the present disclosure is not limited thereto, and the cap body 33 and the shaft coupling member 34 may be formed integrally with each other.

For example, the guide rail 300 may be mounted on the shaft coupling member 34. The shaft coupling member 34 may include a rail mounting portion 34b on which the guide rail 300 is mounted. For example, the rail mounting portion 34b may be formed to be recessed to allow the guide rail 300 to be inserted thereinto. The guide rail 300 may be inserted into the rail mounting portion 34b and mounted on the shaft coupling member 34. When the shaft coupling member 34 rotates about the hinge shaft 70, the guide rail 300 may also rotate about the hinge shaft 70.

For example, the rail mounting portion 34b may have a shape corresponding to the guide rail 300. For example, the guide rail 300 may be inserted into the rail mounting portion 34b and fitted into the rail mounting portion 34b.

For example, the guide rail 300 may be fastened to the shaft coupling member 34 by a fastening member (not shown). The guide rail 300 may include a fastening hole 303h, and the guide rail 300 may be fastened to the shaft coupling member 34 by a fastening member (e.g., screw) that penetrates the fastening hole 303h and the shaft coupling member 34. However, the present disclosure is not limited thereto, and the guide rail 300 may be coupled to the shaft coupling member 34 in various ways.

For example, the guide rail 300 may be provided to be separable from another portion of the door 30. Particularly, the guide rail 300 may be removably coupled to the shaft coupling member 34. The guide rail 300 may be removably mounted on the rail mounting portion 34b of the shaft coupling member 34. In this case, even when the guide rail 300 is worn by friction with the guide shaft 45 as the door 30 is repeatedly opened and closed, a user can easily replace only the guide rail 300.

However, the present disclosure is not limited thereto, and the guide rail 300 may be formed integrally with another portion of the door 30, such as the shaft coupling member 34 and the cap body 33.

The guide rail 300 may be provided to allow at least a portion of the guide shaft 45, which will be described later, to be inserted thereto. Particularly, the guide rail 300 may have a concave shape that is recessed from the outer surface of the door 30. For example, the guide rail 300 may have a shape that is recessed from the outer surface of the door 30 in a direction parallel to the direction in which the guide shaft 45 extends. For example, the guide rail 300 may have a shape that is recessed from the outer surface of the door 30 in a direction parallel to the extension direction of the rotation axis A of the door 30. For example, the guide rail 300 may have a shape that is recessed from the outer surface of the door 30 along the vertical direction (Z) of the refrigerator 1. Particularly, the guide rail 300 may have a shape that is recessed downward from the upper surface of the door 30.

The guide rail 300 may include a first inner wall 301 and a second inner wall 302 facing each other, and a third inner wall 303 connecting the first inner wall 301 and the second inner wall 302. The guide shaft 45, which will be described later, may be inserted into a space formed by the first inner wall 301, the second inner wall 302, and the third inner wall 303.

The first inner wall 301 and the second inner wall 302 may each extend in a direction parallel to the extension direction of the guide shaft 45 (e.g., up and down direction). The first inner wall 301 and the second inner wall 302 may face each other with respect to a direction perpendicular to the extension direction of the guide shaft 45 (e.g., vertical direction).

The first inner wall 301 and the second inner wall 302 may be arranged to face each other at spaced apart positions. The first inner wall 301 and the second inner wall 302 may be connected to each other at both ends.

For example, the first inner wall 301 and the second inner wall 302 may each be formed in the shape of an arc approximately centered on the rotation axis A of the door 30.

The third inner wall 303 may form a bottom surface of the guide rail 300. The third inner wall 303 may be arranged to be substantially perpendicular to the extension direction of the guide shaft 45. The third inner wall 303 may be substantially perpendicular to the first inner wall 301 and the second inner wall 302, respectively. The third inner wall 303 may extend in a substantially horizontal direction (a direction parallel to the XY plane).

The guide rail 300 may be formed to allow a side opposite to the third inner wall 303 to open. That is, an opening may be formed on the side opposite to the third inner wall 303 of the guide rail 300, and the guide shaft 45, which will be described later, may be inserted into the guide rail 300 through the opening of the guide rail 300. In other words, the guide shaft 45 may extend toward the third inner wall 303 by passing through the opening of the guide rail 300.

For example, the fastening hole 303h of the guide rail 300 may be formed in the third inner wall 303. The guide rail 300 may be fastened to the shaft coupling member 34 by a fastening member penetrating the third inner wall 303 and the rail mounting portion 34b.

The refrigerator 1 may include the guide shaft 45. The guide shaft 45 may be provided to guide the rotation of the door 30. Particularly, the guide shaft 45 may be inserted into the guide rail 300 and provided to guide the guide rail 300 while the door 30 is being opened and closed. As the guide shaft 45 guides the guide rail 300, the rotation of the door 30 may be guided by the guide shaft 45.

The guide shaft 45 may extend in a direction parallel to the rotation axis A of the door 30. The guide shaft 45 may extend substantially parallel to the vertical direction of the refrigerator 1. The guide shaft 45 may extend from the door support portion 40b of the hinge bracket 40 toward the guide rail 300. For example, the guide shaft 45 may extend downward from the door support portion 40b.

The guide shaft 45 may be disposed at a position spaced apart from the rotation axis A of the door 30.

The guide shaft 45 may be fixed to the main body 10. Particularly, the guide shaft 45 may be provided on the hinge bracket 40 fixed to the main body 10 and thus the guide shaft 45 may be fixed to the main body 10. That is, the hinge bracket 40 may include the guide shaft 45. When the door 30 rotates, the guide rail 300 may rotate but the guide shaft 45 may be fixed. Accordingly, the movement of the guide rail 30 may be guided by the guide shaft 45.

For example, the guide shaft 45 may be fixed to the door support portion 40b of the hinge bracket 40. The door support portion 40b may include a guide shaft coupling portion 40e to which the guide shaft 45 is coupled. The guide shaft 45 may include a hinge bracket fixing portion 45b fixed to the guide shaft coupling portion 40e. For example, the guide shaft 45 may be fixed to the door support portion 40b as the hinge bracket fixing portion 45b penetrates the guide shaft coupling portion 40e.

For example, the guide shaft 45 may include a hinge bracket support portion 45c provided to be in contact with the door support portion 40b. The hinge bracket support portion 45c may have a greater width than the hinge bracket fixing portion 45b. Further, the hinge bracket support portion 45c may have a width greater than a diameter of the hole provided in the guide shaft coupling portion 40e. For example, the hinge bracket support portion 45c may be disposed between the hinge bracket fixing portion 45b and a rail insertion portion 45a, which will be described later. Further, the hinge bracket support portion 45c may be disposed between the guide shaft coupling portion 40e and the rail insertion portion 45a. As shown in the drawing, the hinge bracket support portion 45c may be in contact with the lower side of the guide shaft coupling portion 40e. For example, the hinge bracket support portion 45c may be formed in a flat plate shape. Accordingly, the guide shaft 45 may be more firmly coupled to the door support portion 40b.

For example, the guide shaft 45 may be removably coupled to the guide shaft coupling portion 40e. Accordingly, when the guide shaft 45 is worn as the door 30 is repeatedly opened and closed, a user can easily replace the guide shaft 45.

However, the present disclosure is not limited thereto, and the guide shaft 45 may be formed integrally with another portion of the hinge bracket 40.

At least a portion of the guide shaft 45 may be provided to be inserted into the guide rail 300. The guide shaft 45 may include the rail insertion portion 45a provided to be inserted into the guide rail 300. The rail insertion portion 45a may be covered by the first inner wall 301, the second inner wall 302, and the third inner wall 303 of the guide rail 300. The rail insertion portion 45a may be inserted into the space inside the guide rail 300 formed by the first inner wall 301, the second inner wall 302, and the third inner wall 303 of the guide rail 300. The rail insertion portion 45a may be inserted into the guide rail 300 to guide the rotation of the guide rail 300.

For example, the rail insertion portion 45a may be formed in a bar shape extending in one direction. For example, the rail insertion portion 45a may be formed to have a substantially cylindrical shape.

The rail insertion portion 45a may extend in a direction parallel to the rotation axis A of the door 30. The rail insertion portion 45a may extend substantially parallel to the vertical direction of the refrigerator 1. The rail insertion portion 45a may extend from the hinge bracket support portion 45c toward the guide rail 300. For example, the rail insertion portion 45a may extend downward from the hinge bracket support portion 45c.

The guide rail 300 may be disposed on one surface of the door 30 facing the hinge bracket 40, and the guide shaft 45 may extend from the hinge bracket 40 in a direction toward the guide rail 300.

The guide shaft 45 may be provided on the hinge bracket 40, and the guide rail 300 may be provided on the door 30 having a larger area than the hinge bracket 40. Accordingly, a load that is applied to the guide rail 300 by the guide shaft 45 may be easily distributed.

The guide shaft 45 may be arranged to be spaced apart from the third inner wall 303 of the guide rail 300. That is, the rail insertion portion 45a may be arranged to be spaced apart from the third inner wall 303. The extended length of the rail insertion portion 45a may be less than a depth of the guide rail 300. Accordingly, wear caused by friction between the guide shaft 45 and the guide rail 300 may be reduced.

For example, the guide shaft 45 and the guide rail 300 may be formed of different materials.

It is appropriate that the guide rail 300 is formed of a material with high rigidity. In addition, it is appropriate that the guide rail 300 is formed of a material that has a relatively low coefficient of friction with the guide shaft 45. For example, the guide shaft 45 may be formed of a material containing metal. For example, the guide rail 300 may be formed of a material that has high rigidity and a low coefficient of friction with the counterpart, such as polyoxymethylene (POM) or Polyamide 66 (PA66 or nylon 66).

However, the present disclosure is not limited thereto, and the guide shaft 45 and guide rail 300 may each be formed of various materials.

In one embodiment of the present disclosure, the refrigerator 1 may include the guide shaft 45 and the guide rail 300 provided to move along the guide shaft 45, and thus the refrigerator 1 may guide the position of the door 30 when the door 30 moves from the closed position to the open position.

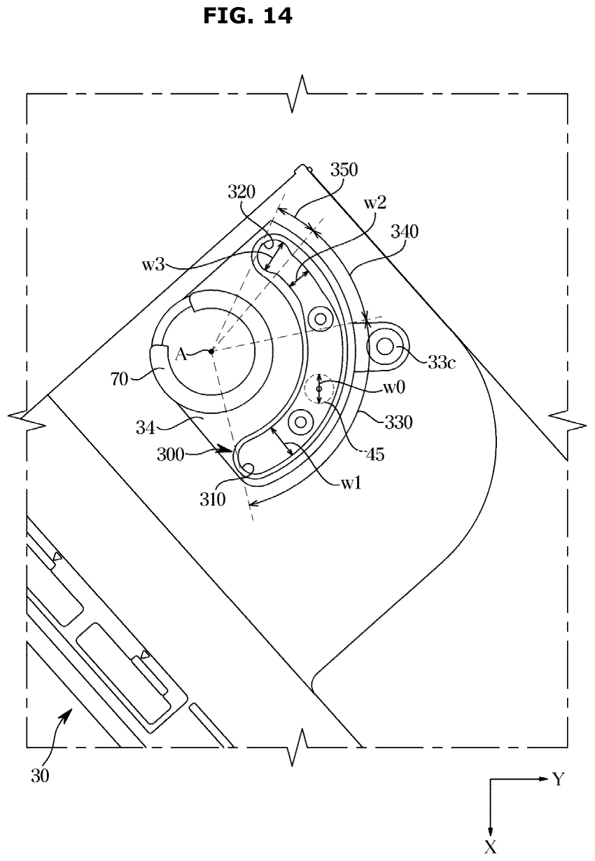

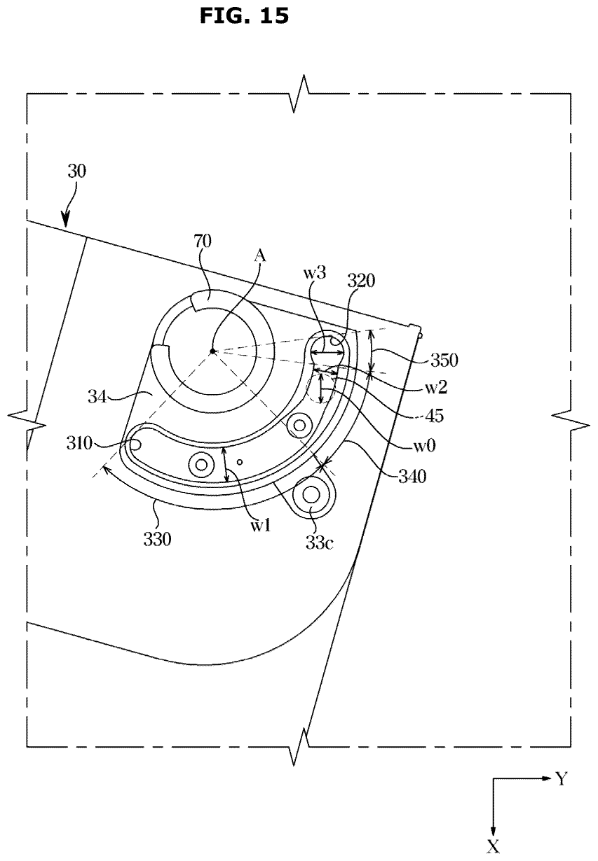

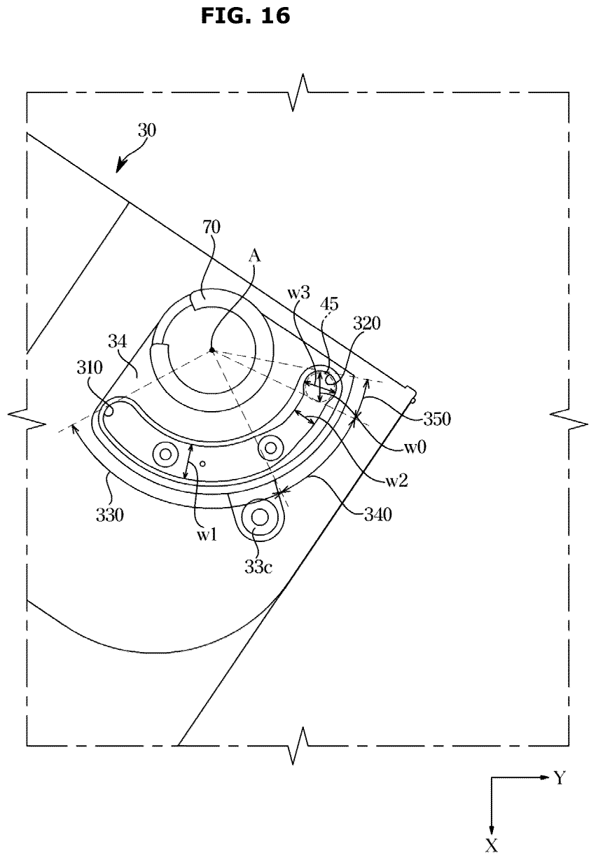

FIG. 13 is a view illustrating the guide rail and a guide shaft when the door of the refrigerator according to one embodiment of the present disclosure is located in a closed position. FIG. 14 is a view illustrating the guide rail and the guide shaft when the door of the refrigerator according to one embodiment of the present disclosure rotates from the closed position to an open position. FIG. 15 is a view illustrating the guide rail and the guide shaft when the door of the refrigerator according to one embodiment of the present disclosure rotates from the closed position to the open position. FIG. 16 is a view illustrating the guide rail and the guide shaft when the door of the refrigerator according to one embodiment of the present disclosure rotates from the closed position to the open position.

Referring to FIGS. 13 to 16, the guide rail 300 of the refrigerator 1 according to one embodiment of the present disclosure may include a first end 310 and a second end 320. The guide rail 300 may extend between the first end 310 and the second end 320. The guide shaft 45 may be inserted into a space extending between the first end 310 and the second end 320.

The first end 310 of the guide rail 300 may be provided to allow the guide shaft 45 to be located thereon when the door 30 is closed. That is, as shown in FIG. 13, when the door 30 is closed, the guide shaft 45 may be located at the first end 310 of the guide rail 300. Particularly, as shown in FIG. 13, when the door 30 is closed, the guide shaft 45 may be in contact with the first end 310 of the guide rail 300.

The second end 320 of the guide rail 300 may be provided to allow the guide shaft 45 to be located thereon when the door 30 is opened. That is, as shown in FIG. 16, when the door 30 is opened, the guide shaft 45 may be located at the second end 320 of the guide rail 300. Particularly, as shown in FIG. 16, when the door 30 is opened, the guide shaft 45 may be in contact with the second end 320 of the guide rail 300.

A direction, in which the door 30 rotates with respect to the rotation axis A while the door 30 is being opened, is defined as a first direction. A direction opposite to the first direction, that is, a direction in which the door 30 rotates with respect to the rotation axis A while the door 30 is being closed, is defined as a second direction. The first end 310 of the guide rail 300 may prevent the door 30 from further rotating in the second direction when the door 30 is closed. Additionally, the second end 320 of the guide rail 300 may prevent the door 30 from further rotating in the first direction when the door 30 is opened.

Therefore, the door 30 may be movable between a position in which the first end 310 of the guide rail 300 is in contact with the guide shaft 45 and a position in which the second end 320 is in contact with the guide shaft 45. As mentioned above, the guide shaft 45 and guide rail 300 may guide the position of the door 30 when the door 30 rotates between the closed position and the open position. Particularly, when the door 30 is rotated from the closed position to the open position and reaches the open position, the guide shaft 45 and the second end 320 of the guide rail 300 may come into contact, and thus the maximum opening angle of the door 30 may be kept constant.

For example, the first end 310 may be formed in a curved shape to approximately correspond to the outer circumferential surface of the rail insertion portion 45a. Additionally, the second end 320 may be formed in a curved shape to approximately correspond to the outer circumferential surface of the rail insertion portion 45a.

As illustrated in FIGS. 13 to 16, when the door 30 rotates, the relative position of the guide shaft 45 may be changed within each area 330, 340, and 350 of the guide rail 300. At this time, in one embodiment of the present disclosure, widths of each area 330, 340, and 350, in which the guide shaft 45 is located within the guide rail 300 as the door 30 rotates, may be different from each other. The width of each area 330, 340, and 350 within the guide rail 300 means a horizontal distance between the first inner wall 301 and the second inner wall 302 of the guide rail 300. Particularly, the width of each area 330, 340, and 350 in the guide rail 300 means a shortest distance in the horizontal direction between the first inner wall 301 and the second inner wall 302 in each area 330, 340, and 350.

Although not shown in the drawing, according to one embodiment, a shock absorption portion provided to absorb shock when coming into contact with the guide shaft 45 may be provided in the first end 310 and/or the second end 320 of the guide rail 300. For example, the shock absorption portion may be formed of various materials with high elasticity, such as silicone and rubber. Accordingly, when the door 30 reaches the closed or open position, it is possible to reduce noise or vibration that may occur when the first end 310 or the second end 320 of the guide rail 300 collides with the guide shaft 45, and it is possible to prevent the guide rail 300 or the guide shaft 45 from being worn or damaged due to collision. Alternatively, the guide rail 300 may not be provided with a separate shock absorbing portion.

The guide rail 300 may include a free area 330 disposed between the first end 310 and the second end 320. The guide shaft 45 may be inserted into the free area 330. As shown in FIGS. 13 and 14, the free area 330 may move along the guide shaft 45 when the door 30 rotates.

The free area 330 may have a first width w1. At this time, the first width w1 of the free area 330 may be greater than or equal to a width w0 of the guide shaft 45. The width w0 of the guide shaft 45 means a width in a direction perpendicular to the extension direction of the guide shaft 45, and means a horizontal width of the guide shaft 45. Particularly, the width w0 of the guide shaft 45 means a width of the rail insertion portion 45a that is a portion inserted into the guide rail 300. When the rail insertion portion 45a has a cylindrical shape, the width w0 may be a diameter of the rail insertion portion 45a.

For example, the width w0 of the guide shaft 45 may be approximately 6.0 mm.

The width w0 of the guide shaft 45 may be less than the first width w1 of the free area 330. In this case, when the guide shaft 45 is located in the free area 330, the outer circumferential surface of the guide shaft 45 may not be in contact with the first inner wall 301 or the second inner wall 302 in the free area 330. Accordingly, while the door 30 rotates between the closed and open positions, the guide rail 300 may not interfere with the guide shaft 45 when the guide shaft 45 is located in the free area 330. That is, when the guide shaft 45 is located in the free area 330, the rotation speed of the door 30 may not be limited by at least the guide rail 300.

For example, the ratio of the first width w1 of the free area 330 to the width w0 of the guide shaft 45 may be approximately 1.2.

FIGS. 13 to 16 illustrate an example in which the first width w1 of the free area 330 is substantially constant along the rotation direction of the door 30, but the present disclosure is not limited thereto.

For example, the free area 330 of the guide rail 300 may extend from the first end 310. Accordingly, when the door 30 begins to rotate from the closed position to the open position, the guide shaft 45 may be disposed within the free area 330 and thus the speed of the door 30 may be not limited.

The guide rail 300 may include a limited area 340 disposed between the second end 320 and the free area 330. The guide shaft 45 may be inserted into the limited area 340. As shown in FIG. 15, the limited area 340 may move along the guide shaft 45 when the door 30 rotates.

As illustrated in FIGS. 14 and 15, the opening angle of the door 30 when the guide shaft 45 is located in the limited area 340 may be greater than the opening angle of the door 30 when the guide shaft 45 is located in the free area 330. In other words, it is assumed that the guide shaft 45 is located in the free area 330 when the door 30 is rotated by the first opening angle from the closed position, and it is assumed that the guide shaft 45 is located in the limited area 340 when the door 30 is rotated by the second opening angle from the closed position, the second opening angle may be greater than the first opening angle.

The limited area 340 may have a second width w2. At this time, the second width w2 may be less than the first width w1. In other words, the ratio of the second width w2 of the limited area 340 to a width w0 of a portion, in which the guide shaft 45 is inserted into the limited area 340 when the guide shaft is located in the limited area 340, may be less than the ratio of the first width w1 of the free area 330 to a width w0 of a portion, in which the guide shaft 45 is inserted into the free area 330 when the guide shaft is located in the free area 330.

Accordingly, the degree/probability of the guide rail 300 interfering with the guide shaft 45 may increase when the guide shaft 45 is located in the limited area 340 compared to when the guide shaft 45 is located in the free area 330. That is, the degree/probability of decelerating the rotation speed of the door 30 may increase when the guide shaft 45 is located in the limited area 340 compared to when the guide shaft 45 is located in the free area 330.

The second width w2 of the limited area 340 may be less than or equal to the width w0 of the guide shaft 45. In this case, when the guide shaft 45 is located within the limited area 340, the outer circumferential surface of the guide shaft 45 may be in contact with the first inner wall 301 and the second inner wall 302 in the limited area 340. Accordingly, while the door 30 rotates, the guide rail 300 may interfere with the guide shaft 45. That is, when the guide shaft 45 is located in the limited area 340, the rotation speed of the door 30 may be limited by the guide rail 300 and may be gradually reduced.

Further, the second width w2 of the limited area 340 may be less than the width w0 of the guide shaft 45. Accordingly, the rotation speed of the door 30 may be reduced more efficiently.

For example, the ratio of the second width w2 of the limited area 340 to the width w0 of the guide shaft 45 may be approximately 0.6 to 0.8.

Even when the second width w2 of the limited area 340 is less than the width w0 of the guide shaft 45, the door 30 may have sufficient momentum while the door 30 is being opened. Therefore, despite of the limited area 340, the door 30 may be rotated to the maximum open position. Particularly, when the coefficient of friction between the guide rail 300 and the guide shaft 45 is designed to be sufficiently low, the door 30 may be rotated to the maximum open position despite of the limited area 340.

An extended length of the free area 330 may be greater than an extended length of the limited area 340. In other words, an angle by which the door 30 is rotated while the guide shaft 45 is in contact with the free area 330 may be greater than an angle by which the door 30 is rotated while the guide shaft 45 is in contact with the limited area 340.

The guide rail 300 may further include an end area 350, which is an area between the second end 320 and the limited area 340. The guide shaft 45 may be inserted into the end area 350. As shown in FIG. 16, while door 30 is being opened, the end area 350 may move toward the guide shaft 45. Further, as shown in FIG. 16, as the end area 350 reaches the guide shaft 45, the guide shaft 45 may be in contact with the second end 320 and the door 30 may reach the open position.

As illustrated in FIGS. 14 to 16, the open angle of the door 30 when the guide shaft 45 is located in the limited area 340 may be greater than the opening angle of the door 30 when the guide shaft 45 is located in the free area 330. In addition, the open angle of the door 30 when the guide shaft 45 is located in the end area 350 may be greater than the opening angle of the door 30 when the guide shaft 45 is located in the limited area 340. In other words, when it is assumed that the guide shaft 45 is located in the limited area 340 when the door 30 is rotated by the second opening angle from the closed position, and it is assumed that the guide shaft 45 is located in the end area 350 when the door 30 is rotated by a third opening angle from the closed position, the third opening angle may be greater than the second opening angle.

The end area 350 may have a third width w3. As shown in the drawing, when the second end 320 has a curved shape, the third width w3 of the end area 350 may not be constant. At this time, the third width w3 of the end area 350 may mean the maximum width within the end area 350.

At this time, the third width w3 may be greater than the second width w2. In other words, the ratio of the third width w3 of the end area 350 to a width w0 of a portion, in which the guide shaft 45 is inserted into the end area 350 when the guide shaft is located in the end area 350, may be greater than the ratio of the second width w2 of the limited area 340 to a width w0 of a portion, in which the guide shaft 45 is inserted into the limited area 340 when the guide shaft is located in the limited area 340.

Further, the third width w3 of the end area 350 may be greater than the width w0 of the guide shaft 45. Accordingly, when the door 30 reaches the open position, the guide shaft 45 may be stably seated in the end area 350, and the guide rail 300 may maintain a constant position with respect to the guide shaft 45.

For example, the third width w3 of the end area 350 may be approximately equal to the first width w1.

An extended length of the end area 350 may be less than the extended length of the limited area 340. In other words, an angle by which the door 30 is rotated while the guide shaft 45 is in contact with the end area 350 may be less than an angle by which the door 30 is rotated while the guide shaft 45 is in contact with the limited area 340.

According to the structure of the guide shaft 45 and the guide rail 300, the door 30 may be guided to the open and closed positions respectively, and the rotation angle range of the door 30 may be limited by the guide shaft 45 and the guide rail 300. Particularly, while the door 30 is being opened, the opening angle may be maintained constant by the second end 320 of the guide rail 300.

Additionally, while the door 30 is being opened, the opening speed of the door 30 may be gradually reduced by the limited area 340 of the guide rail 300. Accordingly, the opening speed of the door 30 may be reduced when the door 30 approaches the open position, and when the door 30 reaches the open position, the door 30 may be naturally stopped. Further, it is possible to prevent components such as the door 30, the hinge shaft 70, the hinge bracket 40, the guide rail 300, and the guide shaft 45 from being worn or damaged caused by the repeat rotation of the door 30. In addition, even when the overall weight of the door 30 changes, the opening speed and maximum opening angle of the door 30 may be kept constant to some extent. Additionally, it is possible to prevent the door 30 from colliding with surrounding structures while the door 30 is being opened. Additionally, it is possible to provide a user with the effect that the door 30 appears to be naturally opened.

In addition, when the door 30 is fully opened, the door 30 may be fixed by the limited area 340 having a width less than the end area 350, and thus the open position may be stably maintained.

It is appropriate that the limited area 340 is disposed in an area adjacent to the second end 320 within the guide rail 300. In other words, it is appropriate for the guide shaft 45 to be designed to be positioned in the limited area 340 when the door 30 almost reaches the open position, or when the door 30 is opened at a sufficiently large angle.

For example, when the opening angle of the door 30 is approximately 90 degrees, the guide shaft 45 may be designed to be located in the limited area 340.

Alternatively, in order to efficiently limit the opening speed of the door 30, the guide shaft 45 may be designed to be located in the limited area 340 or the end area 350 when the door 30 is positioned in a position rotated further toward the opening position than the position in which the lever 130 is in contact with the second contact surface 212 (i.e., when the lever 130 is separated from the second contact surface 212 while the door 30 is rotating toward the open position).

Alternatively, in order to more efficiently limit the opening speed of the door 30, the guide shaft 45 may be designed to be located in the limited area 340 or the end area 350 when the door 30 is positioned between the position in which the lever 130 is in contact with the curved point 213 (the position rotated by the reference angle a0) and the open position.

For example, unlike FIGS. 13 to 16, the limited area 340 may extend to the second end 320 of the guide rail 300. In this case, the opening speed of the door 30 may be limited more efficiently.

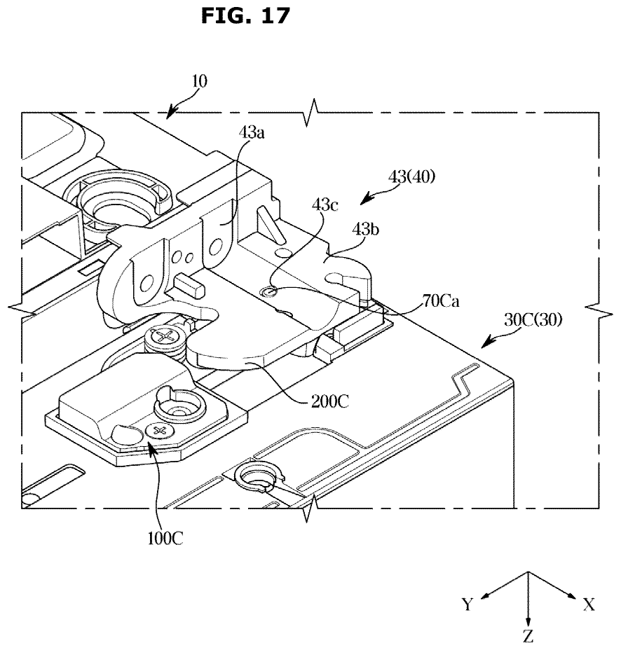

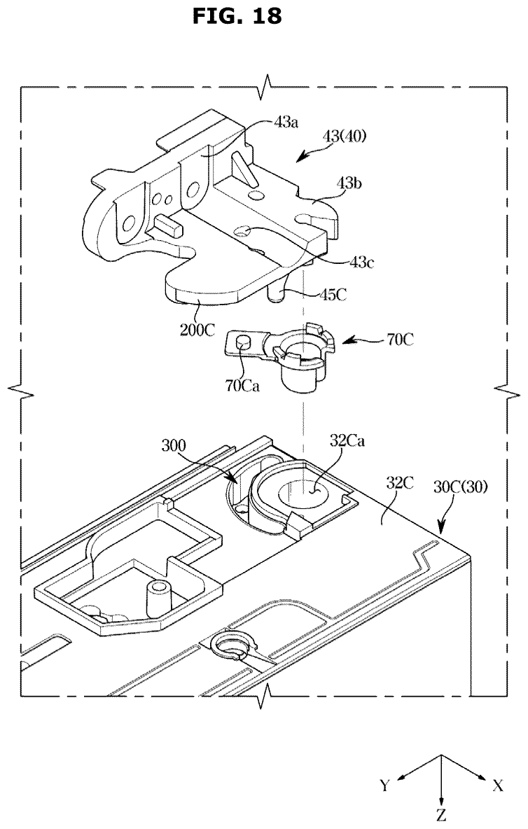

FIG. 17 is a bottom view illustrating some configurations of the refrigerator according to one embodiment of the present disclosure. FIG. 18 is an exploded view illustrating some configurations of the refrigerator according to one embodiment of the present disclosure.

Referring to FIGS. 17 and 18, the refrigerator 1 according to one embodiment of the present disclosure may include the lower door 30C configured to open and close the lower storage compartment 22 of the refrigerator. In FIGS. 17 and 18, description will be described based on the third door 30C, which is the lower left door, but features may be correspondingly applied to the fourth door 30D, which is the lower right door.

The refrigerator 1 may include the lower door hinge bracket 43 configured rotatably support the third door 30C. The lower door hinge bracket 43 may connect the main body 10 and the third door 30C.

The lower door hinge bracket 43 may be fixed to the main body 10. The lower door hinge bracket 43 may include a body fixing portion 43a coupled to the main body 10.

The lower door hinge bracket 43 may include a door support portion 43b provided to support the third door 30C. The body fixing portion 43a and the door support portion 43b may be connected to each other. For example, the body fixing portion 43a and the door support portion 43b may be integrally formed with each other.

The refrigerator 1 may include a hinge shaft 70C provided to rotatably support the third door 30C. The hinge shaft 70C may pass through the rotation axis of the third door 30C. The third door 30C may rotate with respect to the hinge shaft 70C.

For example, a shaft hole 32Ca may be formed in the door cap 32C of the third door 30C, and the hinge shaft 70C may be provided to penetrate the shaft hole 32Ca.

The hinge shaft 70C may be fixed to the lower door hinge bracket 43. For example, the lower door hinge bracket 43 may include a hinge shaft coupling portion 43c, and the hinge shaft 70C may include a hinge bracket coupling protrusion 70Ca inserted into the hinge shaft coupling portion 43c. As the hinge bracket coupling protrusion 70Ca is inserted into the hinge shaft coupling portion 43c, the hinge shaft 70C may be fixed to the lower door hinge bracket 43.

The refrigerator 1 may include a guide 200C and a lever device 100C provided to guide the rotation of the third door 30C and transmit a force to the third door 30C when the third door 30C rotates.

The lever device 100C may be mounted on the third door 30C. For example, the lever device 100C may be mounted on the door cap 32C of the third door 30C.

The guide 200C may be fixed to the main body 10. The guide 200C may be fixed to the hinge bracket 43. For example, as shown in FIGS. 17 and 18, the guide 200C may be formed integrally with the hinge bracket 43. However, the present disclosure is not limited thereto and in the same manner as the guides the 200A and 200B provided on the upper door hinge bracket 41, the guide 200C may be a separate component and then coupled to and fixed to the hinge bracket 43.

Features of the guide 200C and the lever device 100C may correspond to the features of the guide 200 and the lever device 100 described above, and thus detailed descriptions thereof will be omitted.

The refrigerator 1 may include a guide rail 300 provided on the third door 30C. The third door 30C may include the guide rail 300. When the third door 30C rotates, the guide rail 300 may also rotate about the rotation axis of the third door 30C. The guide rail 300 may be arranged to be spaced apart from the rotation axis of the third door 30C. For example, the guide rail 300 may be arranged to be spaced apart from the hinge shaft 70C.

For example, the guide rail 300 may be mounted on the door cap 32C of the third door 30C.

For example, the guide rail 300 may be removably mounted on the door cap 32C of the third door 30C. Alternatively, the guide rail 300 may be provided integrally with the door cap 32C of the third door 30C.

The refrigerator 1 may include a guide shaft 45C disposed on the lower door hinge bracket 43. The lower door hinge bracket 43 may include the guide shaft 45C. The guide shaft 45C may maintain a fixed position relative to main body 10. The guide shaft 45C may be configured to guide the guide rail 300 when the third door 30C rotates. At least a portion of the guide shaft 45C may be inserted into the guide rail 300.

The guide shaft 45C may extend in a direction parallel to the rotation axis of the third door 30C. For example, the guide shaft 45C may extend upward from the lower door hinge bracket 40C.

As illustrated in FIG. 18, the guide shaft 45C may be formed integrally with another portion of the lower door hinge bracket 40C (e.g., the door support portion 43b). Alternatively, the guide shaft 45C may be removably coupled to the door support portion 43b of the lower door hinge bracket 40C.

Features of the structure and operation of the guide rail 300 and the guide shaft 45C correspond to the features of the structure and operation of the guide rail 300 and the guide shaft 45 described above, and thus detailed descriptions thereof will be omitted.

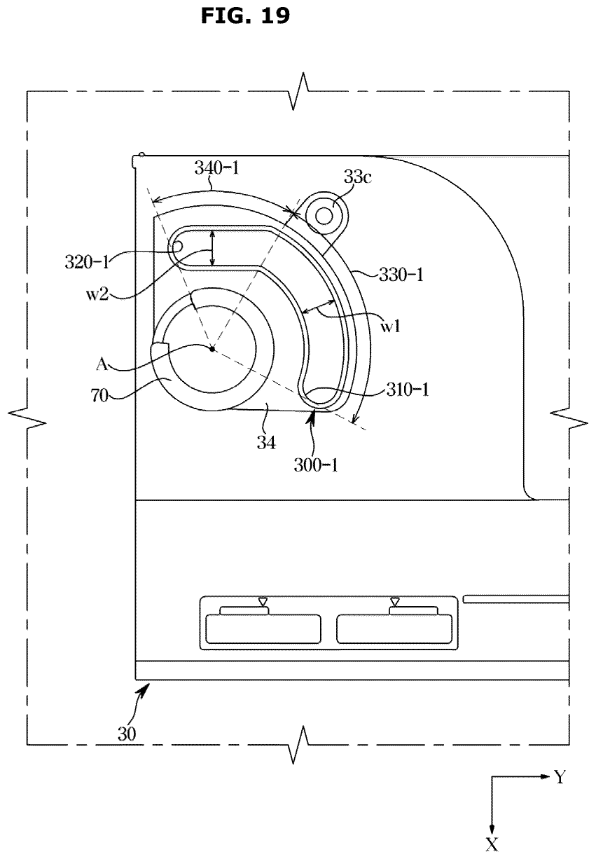

FIG. 19 is a view illustrating a configuration of a door, a shaft coupling member, a hinge shaft, and a guide rail of a refrigerator according to one embodiment of the present disclosure.

As for describing a partial configuration of the refrigerator 1 according to one embodiment of the present disclosure with reference to FIG. 19, configurations corresponding to the configurations of the embodiment shown in FIGS. 1 to 18 may have the same reference numerals and a description thereof will be omitted.

Referring to FIG. 19, the refrigerator 1 according to one embodiment of the present disclosure may include a guide rail 300-1 disposed on the door 30. The door 30 may include the guide rail 300-1. When the door 30 rotates, the guide rail 300-1 may also rotate about the rotation axis A of the door 30. When the door 30 rotates between the closed position and the open position, the movement of the guide rail 300-1 may be guided by the guide shaft 45 (refer to the above-mentioned embodiment).

The guide rail 300-1 may include a first end 310-1 in which the guide shaft 45 is located when the door 30 is in the closed position, and a second end 320-1 in which the guide shaft 45 is located when the door 30 is in the open position. Particularly, when the door 30 is in the closed position, the guide shaft 45 may be in contact with the first end 310-1. when the door 30 is in the open position, the guide shaft 45 may be in contact with the second end 320-1. The guide rail 300-1 may extend between the first end 310-1 and the second end 320-1.

The guide rail 300-1 may include a free area 330-1 and a limited area 340-1. The free area 330-1 may be disposed between the first end 310-1 and the second end 320-1. The limited area 340-1 may be disposed between the second end 320-1 and the free area 330-1.

A width w1 of the free area 330-1 may be greater than or equal to a width of the guide shaft 45 inserted into the free area 330-1. Further, the width w1 of the free area 330-1 may be greater than the width of the guide shaft 45 inserted into the free area 330-1.

As shown in FIG. 19, in the free area 330-1, a first inner wall and a second inner wall of the guide rail 300-1 may each formed in the shape of an arc that is approximately centered on the rotation axis A of the door 30. That is, the free area 330-1 may be extended to correspond to the rotation direction of the door 30.

Therefore, when the guide shaft 45 is located in the free area 330-1 of the guide rail 300-1, the guide rail 300-1 may not interfere with the guide shaft 45, and the rotation speed of the door 30 may not be limited by the guide rail 300-1.

Alternatively, the limited area 340-1 may extend in a straight direction. That is, in the limited area 340-1, the first inner wall and the second inner wall of the guide rail 300-1 may each be formed in a planar shape extending in approximately one direction.

In this case, when the limited area 340-1 reaches the guide shaft 45 while the door 30 rotates from the closed position to the open position, the guide rail 300-1 may interfere with the guide shaft 45. At this time, due to the diameter difference between the hinge shaft 70 and the shaft hole 32a, an outer circumferential surface of the hinge shaft 70 and an inner circumferential surface of the shaft accommodating portion 34a may be spaced apart from each other. Accordingly, the door 30 may still rotate with respect to the hinge bracket 40, but the rotation speed of the door 30 may be reduced while a direction of movement trajectory is changed.

For example, the width w1 of the free area 330-1 and a width w2 of the limited area 340-1 may be substantially equal to each other.

Alternatively, in order to more efficiently reduce the rotation speed of the door 30, the width w2 of the limited area 340-1 may be less than the width w1 of the free area 330-1. Further, the width w2 of the limited area 340-1 may be less than the width of the guide shaft 45.

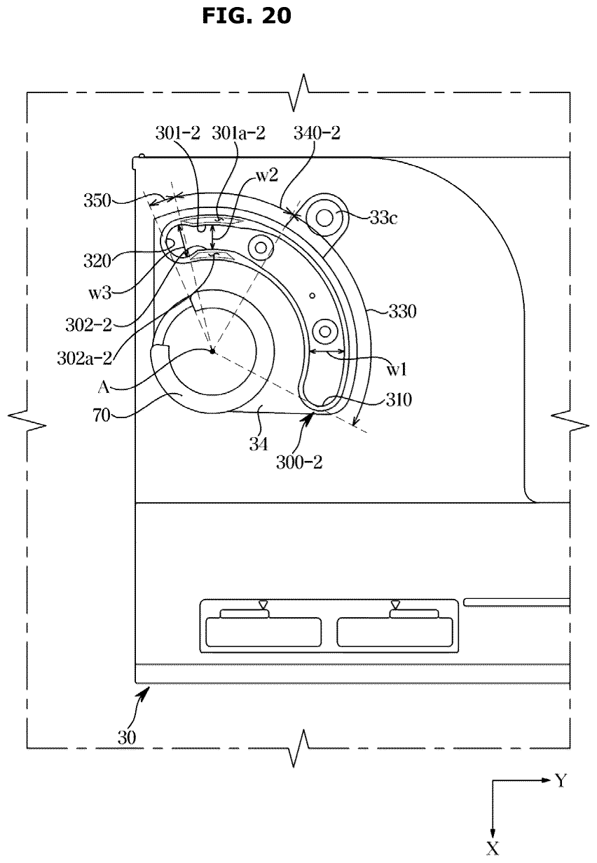

FIG. 20 is a view illustrating a configuration of a door, a shaft coupling member, a hinge shaft, and a guide rail of a refrigerator according to one embodiment of the present disclosure.

As for describing a partial configuration of the refrigerator 1 according to one embodiment of the present disclosure with reference to FIG. 20, configurations corresponding to the configurations of the embodiment shown in FIGS. 1 to 19 may have the same reference numerals and a description thereof will be omitted.

Referring to FIG. 20, the refrigerator 1 according to one embodiment of the present disclosure may include a guide rail 300-2 disposed on the door 30. The door 30 may include the guide rail 300-2. When the door 30 rotates, the guide rail 300-2 may also rotate about the rotation axis A of the door 30. When the door 30 rotates between the closed position and the open position, the movement of the guide rail 300-2 may be guided by the guide shaft 45 (refer to the above-mentioned embodiment).

Descriptions of the first end 310, the second end 320, the free area 330, the end area 350, etc. of the guide rail 300-2 correspond to the guide rail 300 of the embodiments of FIGS. 1 to 18 and thus detailed descriptions thereof will be omitted.

The guide rail 300-2 may include a limited area 340-2. The limited area 340-2 may be disposed between the free area 330 and the second end 320. The limited area 340-2 may be disposed between the free area 330 and the end area 350. The limited area 340-2 may have features corresponding to the limited area 340 described with reference to FIGS. 13 to 16.

When the guide shaft 45 is disposed in the limited area 340-2, a first inner wall 301-2 and a second inner wall 302-2 of the guide rail 300-2 in the limited area 340-2 may be provided to be elastically deformable in order to prevent the guide rail 300-2 or the guide shaft 45 from being worn while limiting the rotation speed of the door 30.

For example, a first cavity 301a-2 may be disposed outside the first inner wall 301-2. The first cavity 301a-2 may be formed between the first inner wall 301-2 and an outer wall of the guide rail 300-2 that is in the limited area 340-2 and adjacent to the first inner wall 301-2. As the first cavity 301a-2 is formed, the first inner wall 301-2 may be elastically deformed outward when pressed.

For example, a second cavity 302a-2 may be disposed outside the second inner wall 302-2. The second cavity 302a-2 may be formed between the second inner wall 302-2 and an outer wall of the guide rail 300-2 that is in the limited area 340-2 and adjacent to the second inner wall 302-2. As the second cavity 302a-2 is formed, the second inner wall 302-2 may be elastically deformed outward when pressed.

With this structure, the limited area 340-2 of the guide rail 300-2 may effectively prevent the guide rail 300-2 to the guide shaft 45 from being worn while limiting the opening speed of the door 30.

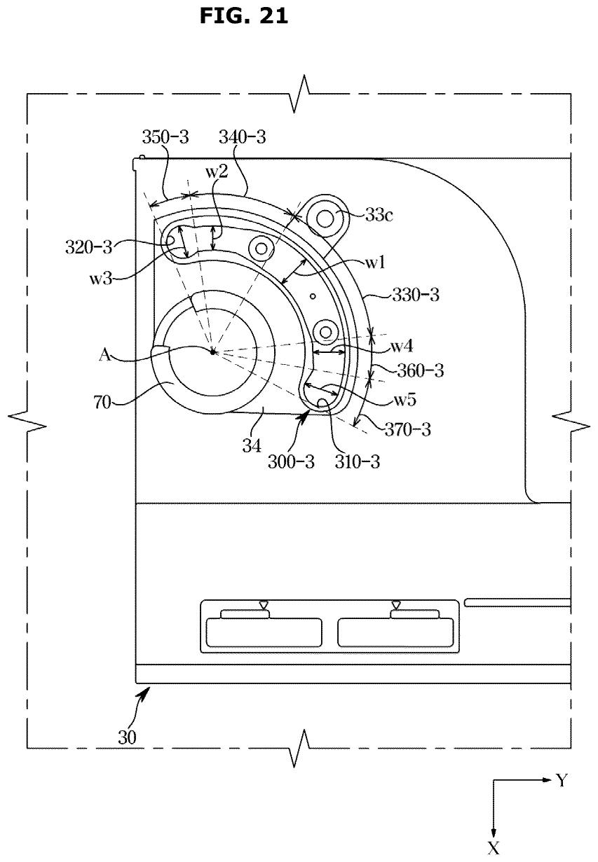

FIG. 21 is a view illustrating a configuration of a door, a shaft coupling member, a hinge shaft, and a guide rail of a refrigerator according to one embodiment of the present disclosure.

As for describing a partial configuration of the refrigerator 1 according to one embodiment of the present disclosure with reference to FIG. 21, configurations corresponding to the configurations of the embodiment shown in FIGS. 1 to 20 may have the same reference numerals and a description thereof will be omitted.

Referring to FIG. 21, the refrigerator 1 according to one embodiment of the present disclosure may include a guide rail 300-3 disposed on the door 30. The door 30 may include the guide rail 300-3. When the door 30 rotates, the guide rail 300-3 may also rotate about the rotation axis A of the door 30. When the door 30 rotates between the closed position and the open position, the movement of the guide rail 300-3 may be guided by the guide shaft 45 (refer to the above-mentioned embodiment).

The guide rail 300-3 may include a first end 310-3 in which the guide shaft 45 is located when the door 30 is in the closed position, and a second end 320-3 in which the guide shaft 45 is located when the door 30 is in the open position. Particularly, when the door 30 is in the closed position, the guide shaft 45 may be in contact with the first end 310-3. when the door 30 is in the open position, the guide shaft 45 may be in contact with the second end 320-3. The guide rail 300-3 may extend between the first end 310-3 and the second end 320-3.

The guide rail 300-3 may include a free area 330-3 disposed between the first end 310-3 and the second end 320-3. A width w1 of the free area 330-3 may be greater than or equal to a width of the guide shaft 45 inserted into the free area 330-3. For example, the width w1 of the free area 330-3 may be greater than the width of the guide shaft 45 inserted into the free area 330-3, and thus when the guide shaft 45 is located in the free area 330-3, the guide rail 300-3 may not interfere with the guide shaft 45. When the guide shaft 45 is located in the free area 330-3, the rotation speed of the door 30 may not be limited.

The guide rail 300-3 may include an opening limited area 340-3 disposed between the second end 320-3 and the free area 330-3. The opening limited area 340-3 may have a second width w2 that is less than the first width w1 of the free area 330-3. Further, the second width w2 of the opening limited area 340-3 may be less than or equal to the width of the guide shaft 45. Accordingly, when the guide shaft 45 is located in the opening limited area 340-3, the guide rail 300-3 may interfere with the guide shaft 45, and the opening speed of the door 30 may be limited.

The guide rail 300-3 may include a first end area 350-3 disposed between the second end 320-3 and the opening limited area 330-3. For example, a third width w3 of the first end area 350-3 may be greater than the second width w2 of the opening limited area 330-3. Further, the third width w3 of the first end area 350-3 may be greater than or equal to the width of the guide shaft 45.

Further, the guide rail 300-3 may include a closing limited area 360-3 disposed between the first end 310-3 and the free area 330-3. The closing limited area 360-3 may have a fourth width w4 that is less than the first width w1 of the free area 330-3. Further, the fourth width w4 of the closing limited area 360-3 may be less than or equal to the width of the guide shaft 45. Accordingly, when the guide shaft 45 is located in the closing limited area 360-3, the guide rail 300-3 may interfere with the guide shaft 45, and the closing speed of the door 30 may be limited.

Additionally, the guide rail 300-3 may include a second end area 370-3 disposed between the second end 320-3 and the closing limited area 360-3. For example, a fifth width w5 of the second end area 370-3 may be greater than the fourth width w4 of the closing limited area 360-3. Further, the fifth width w5 of the second end area 370-3 may be greater than or equal to the width of the guide shaft 45.

With this structure, the opening speed of the door 30 may be limited by the opening limited area 340-3 of the guide rail 300-3, and at the same time, the closing speed of the door 30 may be limited by the closing limited area 360-3 of the guide rail 300-3.

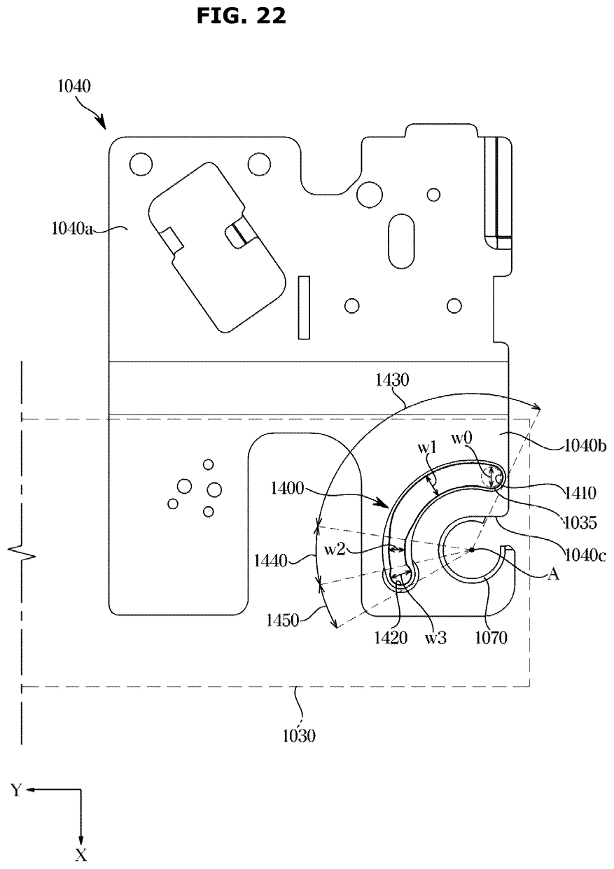

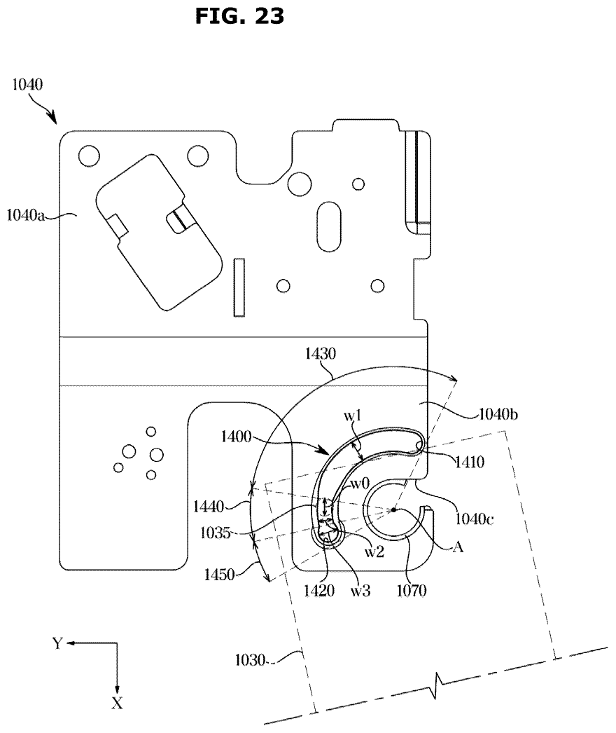

FIG. 22 is a view illustrating a configuration of a door, a guide shaft, a hinge bracket, and a guide rail when the door of a refrigerator according to one embodiment of the present disclosure is in a closed position. FIG. 23 is a view illustrating the configuration of the door, the guide shaft, the hinge bracket, and the guide rail when the door of the refrigerator according to one embodiment of the present disclosure is in an open position.

Referring to FIGS. 22 and 23, the refrigerator 1 according to one embodiment of the present disclosure may include a main body 10 (refer to the above-mentioned embodiment) and a door 1030 configured to be rotatable with respect to the main body 10.

The refrigerator 1 may include a hinge bracket 1040 provided to connect the main body 10 and the door 1030. The hinge bracket 1040 may be coupled to the main body 10 and the door 1030. The hinge bracket 1040 may rotatably support the door 1030.

Particularly, the hinge bracket 1040 may include a body fixing portion 1040a fixed to the main body 10 and a door support portion 1040b supporting the door 1030. The body fixing portion 1040a and the door support portion 1040b may be connected to each other. The door support portion 1040b may be formed to extend from the body fixing portion 1040a toward the door 1030. For example, the body fixing portion 1040a and the door support portion 1040b may be formed integrally with each other.

The door support portion 1040b may be disposed on one side of the door 1030. On one side of the door 1030, the door support portion 1040b may be disposed adjacent to the rotation axis A of the door 1030. The door support portion 1040b may rotatably support the door 1030.

The refrigerator 1 may include a hinge shaft 70 coupled to the door 1030 and the hinge bracket 1040 and provided to pass through the rotation axis A of the door 1030. The hinge bracket 1040 may rotatably support the door 1030 by the hinge shaft 1070. The hinge bracket 1040 may include a hinge shaft coupling portion 1040c to which the hinge shaft 1070 is coupled, and the hinge shaft coupling portion 1040c may be disposed on the door support portion 1040b. The door 1030 may be configured to be rotatable about the hinge shaft 1070. For example, the hinge shaft coupling portion 1040c may be formed to allow the hinge shaft 1070 to penetrate therethrough.

The refrigerator 1 may include a guide rail 1400 and a guide shaft 1035. Unlike the guide rail 300 and guide shaft 45 according to the embodiment of FIGS. 1 to 21, the guide rail 1400 may be disposed on the hinge bracket 1040, and the guide shaft 1035 may be disposed on the door 1030.

That is, referring to FIGS. 22 and 23, the hinge bracket 1040 may include the guide rail 1400, and the door 1030 may include the guide shaft 1035.

The guide rail 1400 may be fixed to the main body 10. For example, the guide rail 1400 may be fixed to the door support portion 1040b of the hinge bracket 1040. The guide rail 1400 may be removably coupled to the door support 1040b, or may be formed integrally with the door support 1040b.

For example, the guide rail 1400 may be formed to have a shape that penetrates both surfaces of the hinge bracket 1040 in the vertical direction. Alternatively, the guide rail 1400 may be formed to have a groove shape in which one side is closed (particularly, a groove shape that is recessed upward from the lower side facing the door 1030).

The guide shaft 1035 may be configured to rotate with respect to the rotation axis A of the door 1030 when the door 1030 rotates. For example, the guide shaft 1035 may be mounted on the door cap of the door 1030.

The guide shaft 1035 may be inserted into the guide rail 1400. The guide shaft 1035 may extend from the outer surface of the door 1030 toward the guide rail 1400, and at least a portion of the guide shaft 1035 may be inserted into the guide rail 1400. When the door 1030 rotates, the guide shaft 1035 may move along the guide rail 1400. The guide rail 1400 may guide the movement of the guide shaft 1035, thereby guiding the rotation of the door 1030.

Particularly, the guide rail 1400 may include a first end 1410 in which the guide shaft 1035 is located when the door 1030 is in the closed position, and a second end 1420 in which the guide shaft 1035 is located when the door 1030 is in the open position. The guide shaft 1035 may extend between the first end 1410 and the second end 1420.

When the door 1030 is closed, the guide shaft 1035 may be in contact with the first end 1410, and thus the door 1030 may be prevented from further rotating in the direction in which the door 1030 is closed.

When the door 1030 is opened, the guide shaft 1035 may be in contact with the second end 1420, and thus the door 1030 may be prevented from further rotating in the direction in which the door 1030 is opened.

The guide rail 1400 may include a free area 1430 disposed between the first end 1410 and the second end 1420. The free area 1430 may have a first width w1. For example, the first width w1 of the free area 1430 may be greater than or equal to a width w0 of the guide shaft 1035.

The guide rail 1400 may include a limited area 1440 provided between the free area 1430 and the second end 1420. The limited area 1440 may have a second width w2. The second width w2 of the limited area 1440 may be less than the first width w1 of the free area 1430. Further, the second width w2 of the limited area 1440 may be less than or equal to the width w0 of the guide shaft 1035.

Accordingly, while the door 1030 is being opened, the guide shaft 1035 may move from the first end 1410 toward the second end 1420, and at this time, the speed of the guide shaft 1035 and the opening speed of the door 1030 may be limited by the limited area 1440.

The guide rail 1400 may further include an end area 1450 disposed between the limited area 1440 and the second end 1420. The end area 1450 may have a third width w3. The third width w3 of the end area 1450 may be greater than the second width w2 of the limited area 1440. For example, the third width w3 of the end area 1450 may be greater than or equal to the width w0 of the guide shaft 1035. For example, the third width w3 of the end area 1450 may approximately correspond to the first width w1 of the free area 1430. Accordingly, when the door 1030 reaches the open position, the guide shaft 1035 may be stably seated in the end area 1450, and the guide shaft 1035 may maintain a constant position with respect to the guide rail 1400.

However, the refrigerator according to one embodiment may not include configurations for automatically opening the door, and the door may be provided to be opened and closed manually. Even in this embodiment, the structure of the guide rail and the guide shaft configured to guide the rotation of the door and configured to limit the rotation speed of the door may be applied.

The refrigerator 1 according to one embodiment of the present disclosure may include the main body 10 forming the storage compartment 20, the door 30 configured to open and close the storage compartment 20 and provided to be rotatable with respect to the main body 10, and including the guide rail 300 spaced apart from the rotation axis A of the door, and the hinge bracket 40 provided to connect the main body 10 and the door 30 so as to rotatably support the door 30, and including the guide shaft 45 inserted into the guide rail 300 and provided to guide rotation of the door 30. The guide rail 300 may include the first end 310 in which the guide shaft 45 is located in response to the door 30 being in a closed position, the second end 320 in which the guide shaft 45 is located in response to the door 30 being in an open position, the free area 330 disposed between the first end 310 and the second end 320 and having the first width w1, and the limited area 340 disposed between the second end 320 and the free area 330 and having the second width w2 less than the first width w1.

The portion of the guide shaft 45 inserted into the guide rail 300 may have the width w0 greater than the second width w2.

The portion of the guide shaft 45 inserted into the guide rail 300 may have the width w0 less than the first width w1.

The area 350 between the second end 320 and the limited area 340 of the guide rail 300 may have the width w3 greater than the width of the portion of the guide shaft 45 inserted into the guide rail 300.

The width w3 of the area between the second end 320 and the limited area 340 of the guide rail 330 may be equal to the first width w1.

The free area 330 may extend from the first end 310.

The extended length of the free area 330 may be greater than the extended length of the limited area 340.

The guide rail 300 may be disposed on one surface of the door 30 facing the hinge bracket 40. The guide shaft 45 may extend from the hinge bracket 45 to a direction facing the guide rail 300.

The refrigerator 1 may further include the hinge shaft 70 provided to pass through the rotation axis A of the door and coupled to the door 30 and the hinge bracket 40. The guide rail 300 may be arranged to be spaced apart from the hinge shaft 70.

The guide rail 300 may have a shape that is recessed from the outer surface of the door 30 to a direction parallel to an extension direction of the rotation axis A of the door. The guide shaft 45 may extend in a direction parallel to the extension direction of the rotation axis A of the door.

The first end 310 may be provided to be in contact with the guide shaft 45 in response to the door 30 being in the closed position. The second end 320 may be provided to be in contact with the guide shaft 45 in response to the door 30 being in the open position.

The door 30 may be provided to be opened by rotating in the first direction with respect to the rotation axis A and provided to be closed by rotating in the second direction opposite to the first direction. The first end 310 may be in contact with the guide shaft 45 to prevent the door 30 from rotating further in the second direction in response to the door 30 being in the closed position. The second end 320 may be in contact with the guide shaft 45 to prevent the door 30 from rotating further in the first direction in response to the door 30 being in the maximum open position.

The refrigerator 1 may further include the hinge shaft 70 provided to pass through the rotation axis A of the door and coupled to the door 30 and the hinge bracket 40. The door 30 may further include the shaft coupling member 34 to which the hinge shaft 70 is coupled. The guide rail 300 may be coupled to the door 30 so as to be separable from the shaft coupling member 34.

The refrigerator 1 may further include the lever 130 movably mounted on the door 30 and provided to transmit an elastic force to the door 30 while the door 30 is being opened or closed, and the guide 200 fixed to the main body 10 and provided to guide movement of the lever 130 by being in contact with the lever 130 while the door 30 is being opened or closed. The guide 200 may include the first contact surface 211 provided to allow the lever 130 to transmit an elastic force to the door 30 in a direction, in which the door 30 is closed, by being in contact with the lever 130, and the second contact surface 212 provided to allow the lever 130 to transmit an elastic force to the door 30 in a direction, in which the door 30 is opened, by being in contact with the lever 130. The door 30 may be configured to open the storage compartment 20 by rotating in the first direction with respect to the rotation axis A, and configured to close the storage compartment 20 by rotating in the second direction opposite to the first direction. In response to the door 30 being located in a position rotated in the first direction from a position in which the lever 130 is in contact with the second contact surface 212, the guide shaft 45 may be positioned in the limited area 340 or the area 350 between the limited area 340 and the second end 320 of the guide rail 330.

The limited area may be the opening limited area 340-3, and the guide rail 300-3 may further include the closing limited area 360-3 disposed between the first end 310-3 and the free area 330-3 and having the width w4 less than the first width w1.

The refrigerator 1 according to one embodiment of the present disclosure may include the main body 10 forming the storage compartment 20, the door 30 configured to open and close the storage compartment 20 and provided to be rotatable with respect to the main body 10, and including the guide rail 300 spaced apart from the rotation axis A of the door, and the guide shaft 45 provided to maintain a fixed position with respect to the main body 10 and inserted into the guide rail 300 to guide rotation of the guide rail 300. The guide rail 300 may include the first end 310 in which the guide shaft 45 is located in response to the door 30 being in a closed position, the second end 320 in which the guide shaft 45 is located in response to the door 30 being in an open position, the free area 330 disposed between the first end 310 and the second end 320 and having the width w1 greater than or equal to the diameter w0 of the portion of the guide shaft 45 inserted into the guide rail 300, and the limited area 340 disposed between the second end 320 and the free area 330 and having the width w2 less than the diameter w0 of the portion of the guide shaft 45 inserted into the guide rail 300.

The area 350 between the second end 320 and the limited area 340 of the guide rail 300 may have the width w3 greater than the width w0 of the portion of the guide shaft 45 inserted into the guide rail 300.

The refrigerator 1 may further include the hinge bracket 40 provided to connect the main body 10 and the door 30 and provided to allow the door 30 to be rotatable with respect to the main body 10. The guide shaft 45 may be disposed on the hinge bracket 40.

The door 30 may be configured to open the storage compartment 20 by rotating in the first direction with respect to the rotation axis A, and configured to close the storage compartment 20 by rotating in the second direction opposite to the first direction. The first end 310 may be in contact with the guide shaft 45 to prevent the door 30 from rotating further in the second direction in response to the door 30 being in the position of maximally closing the storage compartment 20. The second end 320 may be in contact with the guide shaft 45 to prevent the door 30 from rotating further in the first direction in response to the door 30 being in the position of maximally opening the storage compartment 20.

The refrigerator 1 according to one embodiment of the present disclosure may include the main body 10 forming the storage compartment 20, the door 30 configured to open and close the storage compartment 20 and provided to be rotatable with respect to the main body 10, and including the guide rail 300 spaced apart from the rotation axis A of the door, and the hinge bracket 40 provided to connect the main body 10 and including the guide shaft 45 inserted into the guide rail 300 and provided to guide the guide rail 300 in response to the rotation of the door 30. The guide rail 300 may include the free area 330 in which the guide shaft 45 is located in response to the door 30 being rotated from the closed position by the first opening angle, and the limited area 340 in which the guide shaft 45 is located in response to the door 30 being rotated from the closed position by the second opening angle greater than the first opening angle. The free area 330 may have the first ratio of the width w1 to the width w0 of the portion of the guide shaft 45 inserted into the free area 330 in response to the guide shaft 45 being located in the free area 330, and the limited area 340 may have the second ratio, which is less than the first ratio, of the width w2 to the width w0 of the portion of the guide shaft 45 inserted into the limited area 340 in response to the guide shaft 450 being located in the limited area 340.

As is apparent from the above description, a refrigerator may open a door by including a door opening device.

Further, a refrigerator may open a door by including a lever device and a guide configured to guide movement of the lever device.

Further, a refrigerator may include a guide shaft disposed on a hinge bracket and a guide rail provided to move along the guide shaft, and thus the refrigerator may guide a position of a door when the door moves between a closed position and an open position.

Further, a guide rail of a refrigerator may include a limited area narrower than a free area and thus the refrigerator may gradually reduce a speed of a door when the door is opened.

Further, a guide rail of a refrigerator may include a limited area provided to limit an opening speed of a door, and thus the door may be opened at a certain angle.

Further, a guide rail of a refrigerator may include a limited area disposed adjacent to one end of the guide rail, and thus a door may maintain a position thereof when the door is fully opened.

Additional aspects of the disclosure will be set forth in part in the description which follows and, in part, will be obvious from the description, or may be learned by practice of the disclosure.

While the present disclosure has been particularly described with reference to exemplary embodiments, it should be understood by those of skilled in the art that various changes in form and details may be made without departing from the spirit and scope of the present disclosure.

1. A refrigerator comprising:
a main body forming a storage compartment;
a door configured to open and close the storage compartment and including a guide rail; and
a hinge bracket connecting the main body and the door so that the door is rotatable about a rotation axis between an open position at which the storage compartment is open, and a closed position at which the storage compartment is closed,
wherein
the guide rail is spaced apart from the rotation axis,
the hinge bracket includes a guide shaft inserted into the guide rail and configured to guide rotation of the door, and
the guide rail includes:
a first end where the guide shaft is located when the door is in the closed position,
a second end where the guide shaft is located when the door is in the open position,
a free area between the first end and the second end and having a first width, and
a limited area between the second end and the free area and having a second width which is less than the first width.

2. The refrigerator of claim 1, wherein
a portion of the guide shaft inserted into the guide rail has a width which is greater than the second width.

3. The refrigerator of claim 1, wherein
a portion of the guide shaft inserted into the guide rail has a width which is less than the first width.

4. The refrigerator of claim 1, wherein
an area of the guide rail between the second end and the limited area has a width which is greater than a width of a portion of the guide shaft inserted into the guide rail.

5. The refrigerator of claim 1, wherein
an area of the guide rail between the second end and the limited area has a width which is equal to the first width.

6. The refrigerator of claim 1, wherein
the free area extends from the first end toward the limited area.

7. The refrigerator of claim 1, wherein
a length of the free area is greater than a length of the limited area.

8. The refrigerator of claim 1, wherein
the guide rail is on a surface of the door facing the hinge bracket, and
the guide shaft extends from the hinge bracket toward the guide rail.

9. The refrigerator of claim 1, further comprising:
a hinge shaft coupled to the door and the hinge bracket, and which passes through the rotation axis,
wherein the guide rail is spaced apart from the hinge shaft.

10. The refrigerator of claim 1, wherein
the guide rail is recessed from an outer surface of the door in a direction parallel to the rotation axis, and
the guide shaft is parallel to the rotation axis.

11. The refrigerator of claim 1, wherein
the first end is in contact with the guide shaft when the door is in the closed position, and
the second end is in contact with the guide shaft when the door is in the open position.

12. The refrigerator of claim 11, wherein
the door is rotatable to the open position by rotating the door in a first direction about the rotation axis,
the door is rotatable to the closed position by rotating the door in a second direction about the rotation axis which is opposite to the first direction,
when the door is in the closed position, the first end is in contact with the guide shaft to prevent further rotation of the door in the second direction, and
when the door is in the open position, the second end is in contact with the guide shaft to prevent further rotation of the door in the first direction.

13. The refrigerator of claim 1, further comprising:
a hinge shaft coupled to the door and to the hinge bracket, and which passes through the rotation axis,
wherein the door further includes a shaft coupling member to which the hinge shaft is coupled, and
the guide rail is coupled to the door so as to be separable from the shaft coupling member.

14. The refrigerator of claim 1, further comprising:
a lever movably mounted on the door and configured to transmit an elastic force to the door while the door is being rotated between the open position and the closed position; and
a guide fixed to the main body and configured to guide movement of the lever by being in contact with the lever while the door is being rotated between the open position and the closed position, wherein
the guide includes:
a first contact surface configured so that the lever transmits the elastic force to the door in a direction, in which the door rotates to the closed position, when the lever contacts to the first contact surface, and
a second contact surface configured so that the lever transmits the elastic force to the door in a direction, in which the door rotates to the open position, when the lever contacts to the second contact surface,
the storage compartment is opened by rotating the door in a first direction with respect to the rotation axis, and the storage compartment is closed by rotating the door in a second direction with respect to the rotation axis which is opposite to the first direction, and
when the door is located in a position rotated in the first direction from a position in which the lever is in contact with the second contact surface, the guide shaft is in the limited area or is in an area between the limited area and the second end.

15. The refrigerator of claim 1, wherein
the limited area is an opening limited area; and
the guide rail further includes a closing limited area between the first end and the free area and having a third width which is less than the first width.

16. A refrigerator comprising:
a main body forming a storage compartment;
a door configured to open and close the storage compartment and including a guide rail; and
a hinge bracket connecting the main body and the door so that the door is rotatable about a rotation axis between an open position at which the storage compartment is open, and a closed position at which the storage compartment is closed,
wherein
the guide rail is spaced apart from the rotation axis,
the hinge bracket includes a guide shaft inserted into the guide rail and configured to guide rotation of the door, and
the guide rail includes:
a first end where the guide shaft is located when the door is in the closed position,
a second end where the guide shaft is located when the door is in the open position,
a free area between the first end and the second end and having an arc shape approximately centered on the rotation axis,
a limited area between the second end and the free area and having a linear shape so that the limited area interferes with the relative movement of the guide shaft in the guide rail in the limited area.
